(19) United States
(12) Patent Application Publication
(10) Pub. No.: US 2024/0414514 A1
(43) Pub. Date: Dec. 12, 2024

(54) DATA TRANSMISSION METHOD AND APPARATUS

(71) Applicant: HUAWEI TECHNOLOGIES CO., LTD., Shenzhen,Guangdong (CN)

(72) Inventors: Aimin Xiao, Shanghai (CN); Meng Meng, Shanghai (CN); Jikang Xia, Shanghai (CN); Jianhua Yang, Shanghai (CN)

(73) Assignee: HUAWEI TECHNOLOGIES CO., LTD., Shenzhen,Guangdong (CN)

(21) Appl. No.: 18/700,124

(22) PCT Filed: Sep. 27, 2022
(86) PCT No.: PCT/CN2022/121905

§ 371 Date: Apr. 10, 2024

(30) Foreign Application Priority Data
Oct. 12, 2021 (CN) 202111187778.4

(51) Int. Cl. H04W 8/00; H04B 17/318; H04W 84/12

(52) U.S. Cl. CPC H04W 8/005; H04B 17/318; H04W 84/12

(57) ABSTRACT

A data transmission method and an apparatus are provided and relate to the field of terminal technologies to improve data transmission performance in neighbor awareness networking. The method may be applied to a first electronic device when connected to a first cluster of a first network and includes determining that a to-be-sent data frame exists in a discovery window. The first electronic device attends to sending the to-be-sent data frame in the discovery window.

This application is a National Stage of International Application No. PCT/CN2022/121905 filed on Sep. 27, 2022, which claims priority to Chinese Patent Application No. 202111187778.4 filed on Oct. 12, 2021. Both of the aforementioned applications are hereby incorporated by reference in their entireties.

### TECHNICAL FIELD

This application relates to the field of communication technologies, and in particular, to a data transmission method and an apparatus.

### BACKGROUND

Because of lower tariffs and higher network speeds, Wi-Fi network access has become the first choice for a plurality of users to access a network. A Wi-Fi device is used during Wi-Fi network access. The Wi-Fi device may be a device including a Wi-Fi chip, for example, an access point (access point, AP) or a station (station, STA).

A Wi-Fi network may include neighbor awareness networking (neighbor awareness networking, NAN). The NAN divides, for the device, resources dedicated to transmitting control information and resources dedicated to transmitting data information, and the device may perform communication by using corresponding resources. However, in an existing resource division manner, resources divided by a system for a device are fixed, resulting in low resource utilization and low data transmission performance.

### SUMMARY

This application provides a data transmission method and an apparatus, to improve data transmission performance in neighbor awareness networking.

To achieve the foregoing objectives, embodiments of this application provide the following technical solutions.

According to a first aspect, a data transmission method is provided, and is applied to a first electronic device or a component (for example, a chip system) that can implement a function of the first electronic device. The first electronic device joins a first cluster, a network in which the first cluster is located is a first network, and the method includes: determining that a to-be-sent data frame exists in a discovery window, and sending the data frame in the discovery window. It can be learned that, in addition to exchanging a management frame in a discovery window, a device (for example, the first electronic device) in a cluster may further have an exchange of a data frame in the discovery window based on a service requirement. In this way, idle time domain resources in the discovery window can be used to transmit the data frame, thereby improving time domain resource utilization and avoiding a waste of the idle time domain resources. In addition, because the data frame is not limited to being transmitted only after the discovery window ends, a transmission occasion of the data frame may be advanced to be in the discovery window. In this way, a service latency can be reduced. In conclusion, the technical solutions in embodiments of this application can comprehensively improve data transmission performance.

In a possible design, before the sending the data frame in the discovery window, the method further includes: determining whether a first condition for allowing the first electronic device to send the data frame in the discovery window is met.

The sending the data frame in the discovery window includes: if the first condition is met, sending the data frame in the discovery window.

According to this solution, whether a data frame is allowed to be sent in a discovery window may be dynamically adjusted based on the first condition, so that the data frame can be allowed to be sent in the discovery window under a proper condition.

In a possible design, before the sending the data frame in the discovery window, the method further includes: receiving first indication information from a second electronic device, where the first indication information indicates that the data frame is allowed to be sent in the discovery window, and the second electronic device is a master device.

The sending the data frame in the discovery window includes: sending the data frame in the discovery window based on the first indication information.

According to this solution, another device (for example, the second electronic device) in the cluster may dynamically indicate whether the first electronic device allows the first electronic device to send the data frame in the discovery window, thereby increasing flexibility of data frame scheduling in a WLAN.

In a possible design, the determining that a to-be-sent data frame exists in a discovery window includes: detecting that a to-be-sent data frame already exists in a time period corresponding to the discovery window, or detecting that a to-be-sent data frame newly arrives in a time period corresponding to the discovery window.

In a possible design, before the sending the data frame in the discovery window, the method further includes: receiving a first instruction input by a user, where the first instruction indicates to enable a first function, and the first function is a function of improving data transmission performance.

In a possible design, before the sending the data frame in the discovery window, the method further includes: detecting that a preset scenario exists, and enabling a first function, where the first function is a function of improving data transmission performance.

The preset scenario includes one or a combination of the following scenarios:
the first electronic device starts a preset application, and the to-be-sent data frame is a data frame of the preset application; and the first electronic device enables a preset function of the preset application, and the to-be-sent data frame is a data frame of the preset function.

In a possible design, before the detecting that a preset scenario exists, the method further includes: receiving a second instruction input by a user, where the second instruction is used to set the preset application.

In a possible design, the first condition includes any one or more of the following: a channel busy ratio of the first network is less than a first threshold, a packet loss rate of the first electronic device is less than a second threshold, a retransmission rate of the first electronic device is less than a third threshold, a quantity of devices in the first cluster is less than a fifth threshold, a service priority of the first electronic device is greater than a fourth threshold, and a received signal strength indicator RSSI of the first electronic device is greater than a sixth threshold.

The first condition is a condition that may indicate that the discovery window has an idle time domain resource. In other words, in the technical solutions in embodiments of this application, when it is determined that the discovery window has the idle time domain resource, the electronic device may be allowed to use the discovery window to send the data frame. In this way, a technical problem such as a data frame packet loss caused by congestion of the discovery window can be avoided, and time domain resources of the discovery window can be fully used, so that data transmission performance is improved.

In a possible design, the data frame sent by the first electronic device in the discovery window meets any one or more of the following conditions: a data amount is less than a seventh threshold, a sending rate is less than an eighth threshold, and a quantity of times of sending is less than a ninth threshold.

In this manner, the data amount, the sending rate, and the quantity of times of sending that are sent by the device in the discovery window may be dynamically adjusted by adjusting a value of each threshold, so that the data amount, the sending rate, and the quantity of times of sending match a current network status, thereby obtaining higher data transmission performance.

According to a second aspect, a data transmission method is provided, applied to a second electronic device or a component (for example, a chip system) that can implement a function of the second electronic device. The second electronic device joins a first cluster, the second electronic device is a master device, and a network in which the first cluster is located is a first network, and the method includes: determining first indication information, and sending the first indication information to a first electronic device, where the first indication information indicates that the first electronic device is allowed to send a data frame in a discovery window.

In a possible design, the determining first indication information includes: determining the first indication information when a first condition for allowing the first electronic device to send the data frame in the discovery window is met.

In a possible design, the first condition includes any one or more of the following: a channel busy ratio of the first network is less than a first threshold, a packet loss rate of the first electronic device is less than a second threshold, a retransmission rate of the first electronic device is less than a third threshold, a quantity of devices in the first cluster is less than a fifth threshold, a service priority of the first electronic device is greater than a fourth threshold, and a received signal strength indicator RSSI of the first electronic device is greater than a sixth threshold.

According to a third aspect, a first electronic device is provided. The first electronic device joins a first cluster, a network in which the first cluster is located is a first network, and the device includes:
a processor, configured to determine that a to-be-sent data frame exists in a discovery window; and
a transceiver, configured to send the data frame in the discovery window.

In a possible design, the processor is further configured to determine whether a first condition for allowing the first electronic device to send the data frame in the discovery window is met; and
that the transceiver is configured to send the data frame in the discovery window includes: if the first condition is met, sending the data frame in the discovery window.

In a possible design, the transceiver is further configured to receive first indication information from a second electronic device, where the first indication information indicates that the data frame is allowed to be sent in the discovery window, and the second electronic device is a master device; and
that the transceiver is configured to send the data frame in the discovery window includes: sending the data frame in the discovery window based on the first indication information.

In a possible design, that the processor is configured to determine that a to-be-sent data frame exists in a discovery window includes: detecting that a to-be-sent data frame already exists in a time period corresponding to the discovery window, or detecting that a to-be-sent data frame newly arrives in a time period corresponding to the discovery window.

In a possible design, the processor is further configured to receive a first instruction input by a user, where the first instruction indicates to enable a first function, and the first function is a function of improving data transmission performance.

In a possible design, the processor is further configured to: detect that a preset scenario exists, and enable a first function, where the first function is a function of improving data transmission performance.

The preset scenario includes one or a combination of the following scenarios:
the first electronic device starts a preset application, and the to-be-sent data frame is a data frame of the preset application; and the first electronic device enables a preset function of the preset application, and the to-be-sent data frame is a data frame of the preset function.

In a possible design, the processor is further configured to receive a second instruction input by the user, where the second instruction is used to set the preset application.

In a possible design, the first condition includes any one or more of the following: a channel busy ratio of the first network is less than a first threshold, a packet loss rate of the first electronic device is less than a second threshold, a retransmission rate of the first electronic device is less than a third threshold, a quantity of devices in the first cluster is less than a fifth threshold, a service priority of the first electronic device is greater than a fourth threshold, and a received signal strength indicator RSSI of the first electronic device is greater than a sixth threshold.

In a possible design, the data frame sent by the first electronic device in the discovery window meets any one or more of the following conditions: a data amount is less than a seventh threshold, a sending rate is less than an eighth threshold, and a quantity of times of sending is less than a ninth threshold.

According to a fourth aspect, a second electronic device is provided. The second electronic device joins a first cluster, the second electronic device is a master device, a network in which the first cluster is located is a first network, and the device includes:
a processor, configured to determine first indication information; and
a transceiver, configured to send the first indication information to a first electronic device, where the first indication information indicates that the first electronic device is allowed to send a data frame in a discovery window.

In a possible design, that the processor is configured to determine first indication information includes: determining the first indication information when a first condition for allowing the first electronic device to send the data frame in the discovery window is met.

In a possible design, the first condition includes any one or more of the following: a channel busy ratio of the first network is less than a first threshold, a packet loss rate of the first electronic device is less than a second threshold, a retransmission rate of the first electronic device is less than a third threshold, a quantity of devices in the first cluster is less than a fifth threshold, a service priority of the first electronic device is greater than a fourth threshold, and a received signal strength indicator RSSI of the first electronic device is greater than a sixth threshold.

According to a fifth aspect, an electronic device is provided, including a processor, a memory, and a Wi-Fi module. The memory and the Wi-Fi module are coupled to the processor, the memory is configured to store computer program code, the computer program code includes computer instructions, and when the processor reads the computer instructions from the memory, the electronic device is enabled to perform the method according to any one of the foregoing aspects and the possible implementations of the foregoing aspects.

According to a sixth aspect, an apparatus is provided. The apparatus is included in an electronic device, and the apparatus has a function of implementing behavior of the electronic device in any method according to the foregoing aspects and the possible implementations of the foregoing aspects. The function may be implemented by hardware, or may be implemented by executing corresponding software by hardware. The hardware or the software includes at least one module or unit corresponding to the foregoing function, for example, a communication module or unit, or a control module or unit.

According to a seventh aspect, a computer-readable storage medium is provided, including computer instructions. When the computer instructions are run on an electronic device, the electronic device is enabled to perform the method according to any one of the foregoing aspects and the possible implementations of the foregoing aspects.

According to an eighth aspect, a computer program product is provided. When the computer program product runs on a computer, the computer is enabled to perform the method according to any one of the foregoing aspects and the possible implementations of the foregoing aspects.

According to a ninth aspect, a chip system is provided, including a processor. When the processor executes instructions, the processor performs the method according to any one of the foregoing aspects and the possible implementations of the foregoing aspects.

According to a tenth aspect, a data transmission system is provided, including a first electronic device (or a chip system implementing a function of the first electronic device) and a second electronic device (or a chip system implementing a function of the second electronic device) according to any possible design of any one of the foregoing aspects.

### BRIEF DESCRIPTION OF DRAWINGS

FIG. 1 is a schematic diagram of an architecture of a system according to an embodiment of this application;

FIG. 2A is a schematic diagram of a scheduling period according to an embodiment of this application;

FIG. 2B is an example diagram of a data transmission method according to an embodiment of this application;

FIG. 3 and FIG. 4 are schematic diagrams of a structure of an electronic device according to an embodiment of this application;

FIG. 5 is an example diagram of a data transmission method according to an embodiment of this application;

FIG. 6A, FIG. 6B(1) to FIG. 6B(3), and FIG. 7(1) to FIG. 7(4) are schematic diagrams of an interface according to an embodiment of this application;

FIG. 8 is a flowchart of a data transmission method according to an embodiment of this application;

FIG. 9 is a schematic diagram of software queues and hardware queues of a data frame and a management frame according to an embodiment of this application;

FIG. 10 is an example diagram of a data transmission method according to an embodiment of this application;

FIG. 11 is a schematic diagram of a frame format according to an embodiment of this application;

FIG. 12 is a flowchart of a data transmission method according to an embodiment of this application;

FIG. 13 is an example diagram of a data transmission method according to an embodiment of this application;

FIG. 14 to FIG. 16A and FIG. 16B are flowcharts of a data transmission method according to an embodiment of this application;

FIG. 17 to FIG. 19 are schematic diagrams of a frame format according to an embodiment of this application;

FIG. 20 to FIG. 23 are flowcharts of a data transmission method according to an embodiment of this application;

FIG. 24 is a schematic diagram of a frame format according to an embodiment of this application;

FIG. 25 and FIG. 26 are schematic diagrams of an interface according to an embodiment of this application;

FIG. 27 is a schematic diagram of a core structure of an electronic device according to an embodiment of this application; and

FIG. 28 is a schematic diagram of a structure of a chip system according to an embodiment of this application.

### DESCRIPTION OF EMBODIMENTS

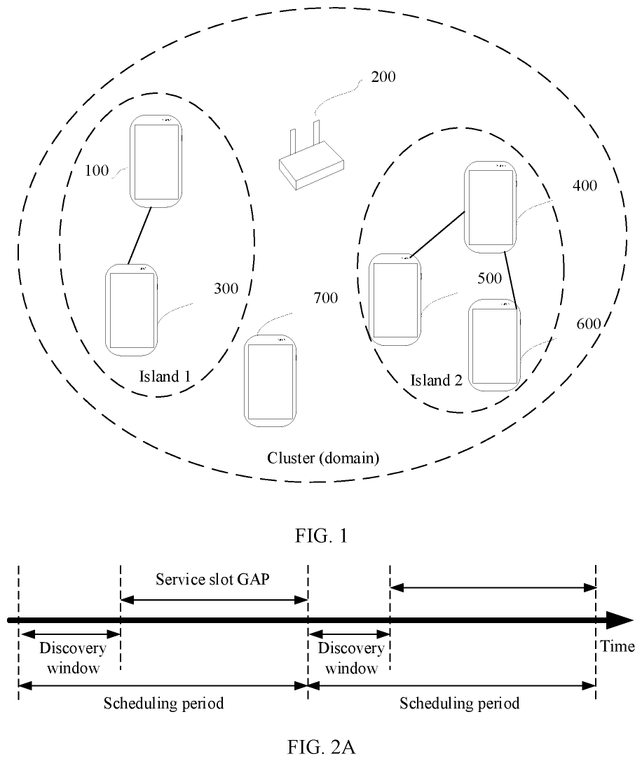

FIG. 1 is a schematic diagram of a structure of a communication system according to an embodiment of this application. The communication system includes an electronic device 100 to an electronic device 700. In this embodiment of this application, the electronic device 100 to the electronic device 700 may be devices that support a WLAN awareness protocol (or referred to as a NAN protocol).

A WLAN awareness function can be enabled on the devices that support the WLAN awareness protocol. After the WLAN awareness function is enabled, the electronic device may discover (discover) a neighboring device adjacent to the electronic device, and may join a cluster to which the neighboring device belongs. As shown in FIG. 1, the electronic device 100 to the electronic device 700 may form a cluster. In a possible implementation, devices in a same cluster share a group of NAN parameters. Optionally, the NAN parameter includes but is not limited to a NAN cluster identifier (ID).

It should be noted that a device in the cluster may be used as a master (master) device or a slave (non-master) device. In a possible implementation, in the cluster, a master device in the cluster may be determined through election among devices. Optionally, a device with a largest master ranking level (master ranking level) value is determined to be the master device. It may be understood that, for a same device, in some cases, the device may be a master device, and in some cases, the device may be a slave device, and a role of the device in a cluster is not fixed. In addition, optionally, the master device may be a device such as an access point, or may be a device such as a station. Similarly, the slave device may be a device such as an access point, or may be a device such as a station.

Optionally, a master ranking level value of a device is related to one or more parameters such as a power level and a device type.

Usually, after a master device in a cluster is determined, the master device may perform a series of operations corresponding to the master device, and a slave device in the cluster performs operations corresponding to the slave device. For example, the operations corresponding to the master device include but are not limited to: sending a beacon (beacon) frame, and carrying time synchronization function (time synchronization function, TSF) clock information in the beacon frame. The operations corresponding to the slave device include but are not limited to: after receiving the beacon frame from the master device, extracting the TSF clock information, and completing time synchronization with the master device based on the TSF clock information. Optionally, the slave device may implement time synchronization with the master device based on the TSF clock information and a locally estimated delay (for example, a local delay from receiving by an antenna port to final processing). Certainly, the slave device may synchronize time in another manner, which is not limited herein.

Subsequently, a device outside the cluster shown in FIG. 1 may discover and join the cluster shown in FIG. 1. In a possible implementation, after enabling a WLAN sensing function, an electronic device 800 (not shown in FIG. 1) may search for a beacon frame. If the electronic device 800 discovers a beacon frame from a master device (for example, an electronic device) in the cluster shown in FIG. 1, the electronic device 800 may synchronize with the electronic device based on the beacon frame. In this way, the electronic device 800 joins the cluster shown in FIG. 1.

In this embodiment of this application, the cluster shown in FIG. 1 may also be referred to as a domain (cluster). Devices in the cluster may include a device that has established a data connection to another device, and a device that has not established a data connection to another device. Generally, devices that establish a data connection can exchange data frames and management frames. Devices that have not established a data connection can exchange management frames but cannot exchange data frames.

Optionally, devices that have established a data connection may form an island (referred to as a data cluster in the NAN protocol). For example, in the cluster shown in FIG. 1, assuming that the electronic devices 300 to 700 are synchronized to a same electronic device, the electronic devices 300 to 700 form a cluster. If a data connection is established between the device 100 and the device 300 in the cluster, the device 100 and the device 300 form an island (other devices may also join the island subsequently). The device 400 establishes a data connection to the device 500, and the device 400 establishes a data connection to the device 600. In this case, the device 400, the device 500, and the device 600 may form an island. The device 700 and the device 200 do not establish a data connection to another device, and the device 700 and the device 200 are not in the island.

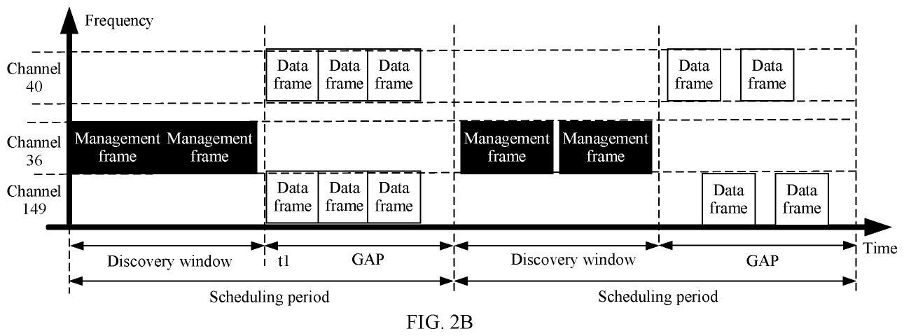

Generally, in time domain, devices in a same cluster perform scheduling based on a same scheduling period and a same discovery window. As shown in FIG. 2A, one scheduling period usually includes one discovery window (discovery window, DW). There is a gap GAP between discovery windows of different scheduling periods. The gap may be used to transmit data, and may be referred to as a service slot or an operating slot. In some solutions, devices in a cluster may exchange a management frame (a frame other than a data frame is collectively referred to as a management frame) in a discovery window of a scheduling period, and exchange a data frame outside the discovery window of the scheduling period. To be specific, the discovery window is usually used to exchange a management frame other than a data frame, and the management frame includes but is not limited to any one or more of the following frames: a beacon frame and a period notification frame (period notification frame, PNF).

In a possible implementation, the master device may broadcast a window parameter. The window parameter includes any two of a discovery window length, a scheduling period, and a service slot length. After another device in the cluster synchronizes with the master device, management frames may be exchanged by periodically switching to the discovery window based on the window parameter. Optionally, in the discovery window of the scheduling period, devices in the cluster may exchange management frames on a same channel. Outside the discovery window of the scheduling period, devices in a same island may exchange data frames on a same channel, and devices in different islands may exchange data frames on different channels. For example, FIG. 2B shows a time domain position and a frequency domain position of a management frame of each device in the cluster shown in FIG. 1. Each device in the cluster shown in FIG. 1 may transmit a management frame on a same common channel 36 in a discovery window of a scheduling period. FIG. 2B further shows time domain positions and frequency domain positions of data frames of some devices in the cluster shown in FIG. 1. FIG. 2B is described by using an example in which the device 100 and the device 300 in the island 1 shown in FIG. 1 exchange data frames by using a channel 40, and the devices 400, 500, and 600 in the island 2 shown in FIG. 1 exchange data frames by using a channel 149.

In some solutions, the time domain positions and/or the frequency domain positions of the data frame and the management frame that are exchanged between the devices in the cluster may alternatively be other, and are not limited to the foregoing manners. For example, for devices of different islands, a same channel may be used to exchange data frames. For example, the island 1 uses a channel 10 to exchange a data frame, and the island 2 also uses the channel 10 to exchange a data frame.

In the foregoing solution, a fastest sending occasion of the data frame is in a non-discovery window of a current scheduling period. FIG. 2B is still used as an example, for the device in the cluster, a fastest sending occasion of a data frame is at an end of a discovery window of the 1^{st} scheduling period, that is, at a moment t1. In this way, a service delay may be caused. For a service with a high requirement for a latency, the service delay severely affects WLAN performance, thereby reducing user experience.

To improve WLAN performance of a terminal, in embodiments of this application, in addition to exchanging a management frame in a discovery window, a device in the cluster may further exchange a data frame in the discovery window based on a service requirement. In this way, idle time domain resources in the discovery window can be used to transmit the data frame, thereby improving time domain resource utilization and avoiding a waste of idle time domain resources in a WLAN. In addition, because the data frame is not limited to being transmitted only after the discovery window ends, a transmission occasion of the data frame may be advanced to be in the discovery window. In this way, a service latency can be reduced. In conclusion, the technical solutions in embodiments of this application can comprehensively improve WLAN transmission performance.

For example, the electronic device in this application may be a mobile phone, a tablet computer, a personal computer (personal computer, PC), a personal digital assistant (personal digital assistant, PDA), a smartwatch, a netbook, a wearable electronic device, an augmented reality (augmented reality, AR) device, a virtual reality (virtual reality, VR) device, a vehicle-mounted device, a smart automobile, a smart speaker, a robot, or the like. A specific form of the electronic device is not specially limited in this application.

In the specification and accompanying drawings of this application, the terms “first”, “second”, and the like are intended to distinguish between different objects or distinguish between different processing on a same object. The words such as “first” and “second” may distinguish between same items or similar items having basically same functions and roles. For example, a first device and a second device are merely intended to distinguish between different devices, and do not limit a sequence thereof. A person skilled in the art may understand that the words such as “first” and “second” do not limit a quantity and an execution order, and the words such as “first” and “second” do not necessarily indicate a difference.

“At least one” means one or more.

“A plurality of” means two or more than two.

“And/or” describes an association relationship between associated objects, and represents that three relationships may exist. For example, A and/or B may represent the following cases: Only A exists, both A and B exist, and only B exists, where A and B may be singular or plural. A character “/” usually indicates an “or” relationship between associated objects. “At least one of the following items (pieces)” or a similar expression thereof indicates any combination of these items, including a single item (piece) or any combination of a plurality of items (pieces). For example, at least one of a, b, or c may represent a, b, c, a and b, a and c, b and c, or a, b, and c, where a, b, and c may be singular or plural.

Moreover, the terms “comprising/including” and “having” and any variations thereof in the descriptions of this application are intended to cover non-exclusive inclusions. For example, a process, a method, a system, a product, or a device that includes a series of steps or units is not limited to steps or units that have been listed, but optionally further includes other unlisted steps or units, or optionally further includes other steps or units inherent to the process, the method, the product, or the device.

It should be noted that in embodiments of this application, the term “example” or “for example” is used to represent giving an example, an illustration, or a description. Any embodiment or design scheme described as an “example” or “for example” in embodiments of this application should not be explained as being more preferred or having more advantages than another embodiment or design scheme. In particular, the term such as “example” or “for example” as used herein is intended to present a related concept in a specific manner.

In the specification and the accompanying drawings of this application, “of (English: of)”, “relevant (English: corresponding or relevant)”, and “corresponding (English: corresponding)” may be used interchangeably sometimes. It should be noted that they mean the same when a difference between them is not emphasized.

A system architecture and a service scenario described in this application are intended to describe the technical solutions of this application more clearly, and do not constitute any limitation to the technical solutions provided in this application. A person of ordinary skill in the art may know that, with evolution of a system architecture and emergence of a new service scenario, the technical solutions provided in this application are also applicable to similar technical problems.

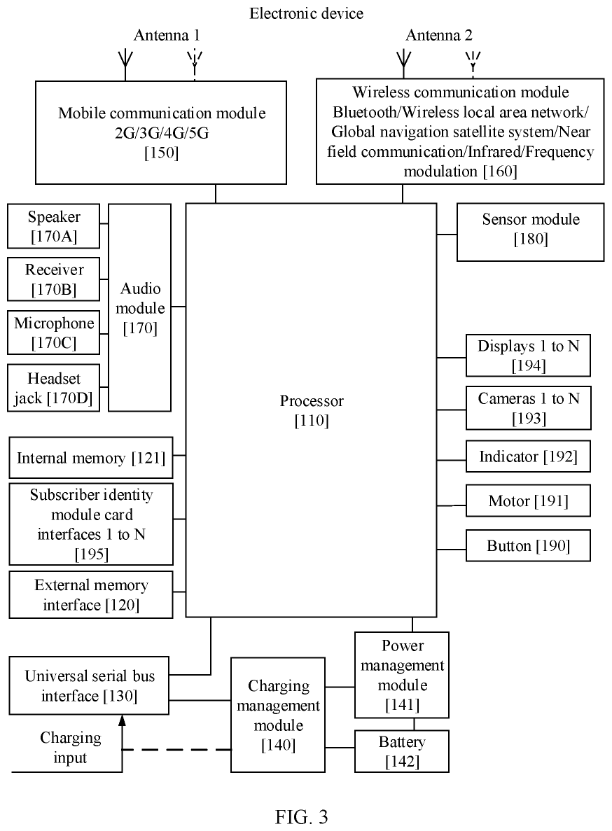

For example, the electronic device is a mobile phone. FIG. 3 is a schematic diagram of a structure of the electronic device. The electronic device may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identity module, SIM) card interface 195, and the like. The sensor module 180 may include a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor (which can detect lightness of ambient light), a bone conduction sensor, and the like.

It may be understood that the structure shown in this embodiment of the present invention does not constitute a specific limitation on the electronic device. In some other embodiments of this application, the electronic device may include more or fewer components than those shown in the figure, some components may be combined, or some components may be split, or different component arrangements may be used. The components in the figure may be implemented by hardware, software or a combination of software and hardware.

The processor 110 may include one or more processing modules. For example, the processor 110 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural-network processing unit (neural-network processing unit, NPU), and/or the like. Different processing units may be independent devices, or may be integrated into one or more processors.

The controller may generate an operation control signal based on an instruction operation code and a time sequence signal, to control instruction reading and instruction execution.

A memory may be further disposed in the processor 110, and is configured to store instructions and data. In some embodiments, the memory in processor 110 is a cache. The memory may store an instruction or datajust used or repeatedly used by the processor 110. If the processor 110 needs to use the instruction or the data again, the processor 110 may directly invoke the instruction or the data from the memory. This avoids repeated access, and reduces waiting time of the processor 110, thereby improving system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The I2C interface is a bidirectional synchronous serial bus, including a serial data line (serial data line, SDA) and a serial clock line (serial clock line, SCL). In some embodiments, the processor 110 may include a plurality of groups of I2C buses. The processor 110 may be separately coupled to the touch sensor, a charger, a flash, the camera 193, and the like by using different I2C bus interfaces. For example, the processor 110 may be coupled to the touch sensor through the I2C interface, so that the processor 110 communicates with the touch sensor through the I2C bus interface, to implement a touch function of the electronic device.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transfer an audio signal to the wireless communication module 160 through the I2S interface, to implement a function of answering a call through a Bluetooth headset.

The PCM interface may also be configured to perform audio communication, and sample, quantize, and encode an analog signal. In some embodiments, the audio module 170 may be coupled to the wireless communication module 160 through a PCM bus interface. In some embodiments, the audio module 170 may alternatively transfer an audio signal to the wireless communication module 160 through the PCM interface, to implement a function of answering a call through a Bluetooth headset. Both the I2S interface and the PCM interface may be configured to perform audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transfer an audio signal to the wireless communication module 160 through the UART interface, to implement a function of playing music through a Bluetooth headset.

The MIPI interface may be configured to connect the processor 110 to a peripheral component like the display 194 or the camera 193. The MIPI interface includes a camera serial interface (camera serial interface, CSI), a display serial interface (display serial interface, DSI), and the like. In some embodiments, the processor 110 communicates with the camera 193 through the CSI interface, to implement a photographing function of the electronic device. The processor 110 communicates with the display 194 through the DSI interface, to implement a display function of the electronic device.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, or the like. The GPIO interface may alternatively be configured as an I2C interface, an I2S interface, a UART interface, an MIPI interface, or the like.

The USB interface 130 is an interface that conforms to the USB standard specification, and may be specifically a mini USB interface, a micro USB interface, a USB Type C interface, or the like. The USB interface 130 may be configured to connect to a charger to charge the electronic device, or may be configured to transmit data between the electronic device and a peripheral device. The USB interface 130 may also be configured to connect to a headset to play audio through the headset. The interface may be further configured to connect to another terminal, for example, an AR device.

It may be understood that an interface connection relationship between the modules shown in this embodiment of this application is merely an example for description, and does not constitute a limitation on the structure of the electronic device. In some other embodiments of this application, the electronic device may alternatively use an interface connection manner different from an interface connection manner in the foregoing embodiment, or use a combination of a plurality of interface connection manners.

The charging management module 140 is configured to receive a charging input from a charger. The charger may be a wireless charger or may be a wired charger. In some embodiments of wired charging, the charging management module 140 may receive a charging input of a wired charger through the USB interface 130. In some embodiments of wireless charging, the charging management module 140 may receive a wireless charging input through a wireless charging coil of the electronic device. The charging management module 140 may further supply power to the electronic device by using the power management module 141 when charging the battery 142.

The power management module 141 is configured to connect to the battery 142, the charging management module 140, and the processor 110. The power management module 141 receives an input of the battery 142 and/or the charging management module 140, to supply power to the processor 110, the internal memory 121, the display 194, the camera 193, the wireless communication module 160, and the like. The power management module 141 may further be configured to monitor parameters such as a battery capacity, a battery cycle count, and a battery state of health (electric leakage and impedance). In some other embodiments, the power management module 141 may alternatively be disposed in the processor 110. In some other embodiments, the power management module 141 and the charging management module 140 may alternatively be disposed in a same component.

A wireless communication function of the electronic device may be implemented through the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the electronic device may be configured to cover one or more communication frequency bands. Different antennas may be further multiplexed to increase antenna utilization. For example, the antenna 1 may be multiplexed as a diversity antenna in a wireless local area network. In some other embodiments, the antenna may be used in combination with a tuning switch.

The mobile communication module 150 may provide a wireless communication solution that includes 2G/3G/4G/5G or the like and that is applied to the electronic device. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit a processed electromagnetic wave to the modem processor for demodulation. The mobile communication module 150 may further amplify a signal modulated by the modem processor, and convert, through the antenna 1, the signal into an electromagnetic wave for radiation. In some embodiments, at least some functional modules of the mobile communication module 150 may be disposed in the processor 110. In some embodiments, at least some functional modules of the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate the received electromagnetic wave signal into a low-frequency baseband signal. Then, the demodulator transmits the low-frequency baseband signal obtained through demodulation to the baseband processor for processing. After being processed by the baseband processor, the low-frequency baseband signal is transmitted to the application processor. The application processor outputs a sound signal by using an audio device (which is not limited to the speaker 170A, the receiver 170B, or the like), or displays an image or a video by using the display 194. In some embodiments, the modem processor may be an independent device. In some other embodiments, the modem processor may be independent of the processor 110, and is disposed in a same device as the mobile communication module 150 or another functional module.

The wireless communication module 160 may provide a wireless communication solution that includes a WLAN (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like and that is used in the electronic device. The wireless communication module 160 may be one or more components integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the to-be-sent signal, and convert, through the antenna 2, the signal into an electromagnetic wave for radiation.

In some embodiments of this application, the processor 110 is configured to: determine that there is a to-be-sent data frame in a discovery window, and control a sending module (for example, a WLAN module) to send the to-be-sent data frame in the discovery window.

In some embodiments, in the electronic device, the antenna 1 is coupled to the mobile communication module 150, and the antenna 2 is coupled to the wireless communication module 160, so that the electronic device can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation system, SBAS).

The electronic device implements a display function by using the GPU, the display 194, the application processor, and the like. The GPU is an image processing microprocessor and connects the display 194 to the application processor. The GPU is configured to perform mathematical and geometric calculations, and is configured for image rendering. The processor 110 may include one or more GPUs, and the one or more GPUs execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light-emitting diode (active-matrix organic light-emitting diode, AMOLED), a flexible light-emitting diode (flexible light-emitting diode, FLED), a mini-LED, a micro-LED, a micro-OLED, a quantum dot light-emitting diode (quantum dot light-emitting diode, QLED), or the like. In some embodiments, the electronic device may include one or N displays 194, where N is a positive integer greater than 1.

The electronic device can implement a photographing function by using the ISP, the camera 193, the video codec, the GPU, the display 194, the application processor, and the like.

The ISP is configured to process data fed back by the camera 193. For example, during photographing, a shutter is pressed, light is transmitted to a photosensitive element of the camera through a lens, an optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected to the photosensitive element. The photosensitive element may be a charge coupled device (charge coupled device, CCD) or a complementary metal-oxide-semiconductor (complementary metal-oxide-semiconductor, CMOS) photoelectric transistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into a standard image signal of a format such as RGB or YUV. In some embodiments, the electronic device may include one or N cameras 193, where N is a positive integer greater than 1.

The digital signal processor is configured to process a digital signal, and may process another digital signal in addition to the digital image signal. For example, when the electronic device selects a frequency, the digital signal processor is configured to perform Fourier transform on frequency energy.

The video codec is configured to compress or decompress a digital video. The electronic device may support one or more video codecs. Therefore, the electronic device may play or record videos in a plurality of coding formats, for example, moving picture experts group (moving picture experts group, MPEG)-1, MPEG-2, MPEG-3, and MPEG-4.

The NPU is a neural-network (neural-network, NN) computing processor, and simulates a biological neural network structure such as a transmission mode between neurons in a human brain to perform rapid processing on input information, and can perform continuous self-learning. Applications such as intelligent cognition of the electronic device may be implemented through the NPU, for example, image recognition, facial recognition, speech recognition, and text understanding.

The external memory interface 120 may be configured to connect to an external storage card, for example, a micro SD card, to extend a storage capability of the electronic device. The external storage card communicates with the processor 110 through the external memory interface 120, to implement a data storage function. For example, files such as music and a video are stored in the external storage card.

The internal memory 121 may be configured to store computer-executable program code, and the executable program code includes instructions. The internal memory 121 may include a program storage area and a data storage area. The program storage area may store an operating system, an application needed by at least one function (for example, a voice playing function or an image playing function), and the like. The data storage area may store data (for example, audio data, and a phone book) created in a process of using the electronic device, and the like. In addition, the internal memory 121 may include a high-speed random access memory, and may further include a nonvolatile memory, for example, at least one magnetic disk storage device, a flash memory device, or a universal flash storage (universal flash storage, UFS). The processor 110 runs instructions stored in the internal memory 121 and/or instructions stored in the memory disposed in the processor, to perform various function applications and data processing of the electronic device.

The electronic device may implement an audio function, for example, music playing and sound recording, by using the audio module 170, the speaker 170A, the receiver 170B, the microphone 170C, the headset jack 170D, the application processor, and the like.

The audio module 170 is configured to convert digital audio information into an analog audio signal for output, and is further configured to convert an analog audio input into a digital audio signal. The audio module 170 may further be configured to encode and decode an audio signal. In some embodiments, the audio module 170 may be disposed in the processor 110, or some functional modules of the audio module 170 are disposed in the processor 110.

The speaker 170A, also referred to as a “horn”, is configured to convert an electrical audio signal into a sound signal. The electronic device may be used to listen to music or answer a hands-free call through the speaker 170A.

The receiver 170B, also referred to as an “earpiece”, is configured to convert an electrical audio signal into a sound signal. When a call is answered or voice information is received through the electronic device, the receiver 170B may be put close to a human ear to listen to a voice.

The microphone 170C, also referred to as a “mike” or a “mic”, is configured to convert a sound signal into an electrical signal. When making a call or sending voice information, a user may make a sound near the microphone 170C through the mouth of the user, to input a sound signal to the microphone 170C. At least one microphone 170C may be disposed in the electronic device. In some other embodiments, two microphones 170C may be disposed in the electronic device, to collect a sound signal and further implement a noise reduction function. In some other embodiments, three, four, or more microphones 170C may alternatively be disposed in the electronic device, to collect a sound signal, implement noise reduction, identify a sound source, implement a directional recording function, and the like.

The headset jack 170D is configured to connect to a wired headset. The headset jack 170D may be the USB interface 130, or may be a 3.5 mm open mobile terminal platform (open mobile terminal platform, OMTP) standard interface or cellular telecommunications industry association of the USA (cellular telecommunications industry association of the USA, CTIA) standard interface.

The button 190 includes a power button, a volume button, and the like. The button 190 may be a mechanical button, or may be a touch button. The electronic device may receive a button input, and generate a button signal input related to a user setting and function control of the electronic device.

The motor 191 may generate a vibration prompt. The motor 191 may be configured to provide an incoming call vibration prompt or a touch vibration feedback. For example, touch operations performed on different applications (for example, photographing and audio playing) may correspond to different vibration feedback effect. The motor 191 may further correspond to different vibration feedback effect for touch operations performed on different areas of the display 194. Different application scenarios (for example, a time reminder, information receiving, an alarm clock, and a game) may also correspond to different vibration feedback effect. Touch vibration feedback effect may alternatively be customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device. The electronic device may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type or of different types. The SIM card interface 195 is compatible to different types of SIM cards. The SIM card interface 195 is further compatible to an external storage card. The electronic device interacts with a network through the SIM card, to implement functions such as conversation and data communication. In some embodiments, the electronic device uses an eSIM, that is, an embedded SIM card. The eSIM card may be embedded into the electronic device, and cannot be separated from the electronic device.

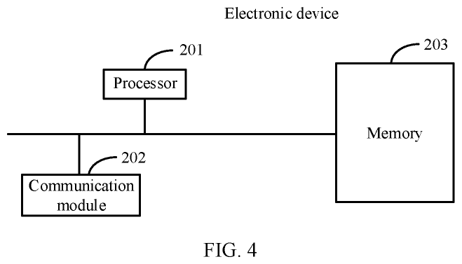

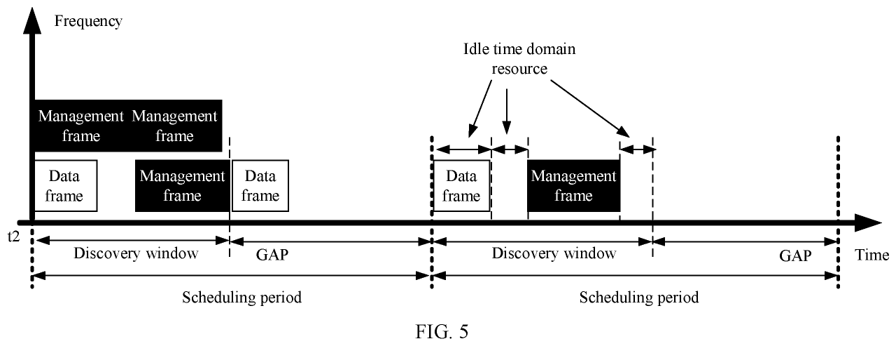

In some other embodiments, the electronic device in this application is a device that may further provide a wireless network access function for the electronic device, for example, a wireless router or customer premises equipment (Customer Premise Equipment, CPE). For example, when the electronic device is a router, as shown in FIG. 4, the electronic device may include a processor 201, a memory 203, a communication module 202, an antenna (not shown in FIG. 4), a power module (not shown in FIG. 4), and the like. The communication module includes a Wi-Fi module, a network access module configured to connect to the Internet, and the like. The Wi-Fi module may be configured to establish a Wi-Fi connection to an electronic device such as a mobile phone. In this way, the mobile phone can use the network access module of the router to access the Internet.

For other content, refer to the descriptions of the related structure in the electronic device in FIG. 3. Details are not described herein again.

All technical solutions in the following embodiments may be implemented on an electronic device that has the foregoing hardware architecture and software architecture.

For example, FIG. 5 shows an application example of a transmission method according to an embodiment of this application. In addition to exchanging a data frame in a service slot (that is, a GAP), a device in a cluster may also exchange a data frame in a discovery window. In comparison with the transmission method shown in FIG. 2B, in the transmission method shown in FIG. 5, some idle time domain resources in the discovery window can be used to transmit the data frame, thereby improving WLAN time domain resource utilization. In addition, a transmission occasion of the data frame may be advanced from an end moment (for example, t1 shown in FIG. 2B) of the discovery window to a moment (for example, t2 shown in FIG. 5) in the discovery window. In this way, a latency of a WLAN service can be reduced. It can be learned that the technical solutions in embodiments of this application can comprehensively improve WLAN transmission performance.

In some embodiments of this application, the electronic device may always enable a WLAN transmission performance enhancement function by default. WLAN transmission performance enhancement may mean that a data frame is allowed to be transmitted in a discovery window in a WLAN transmission process.

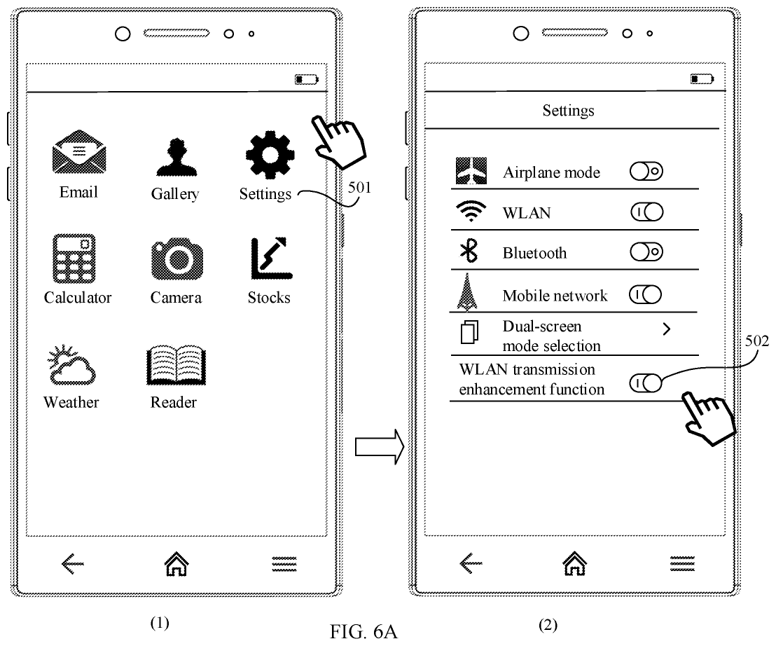

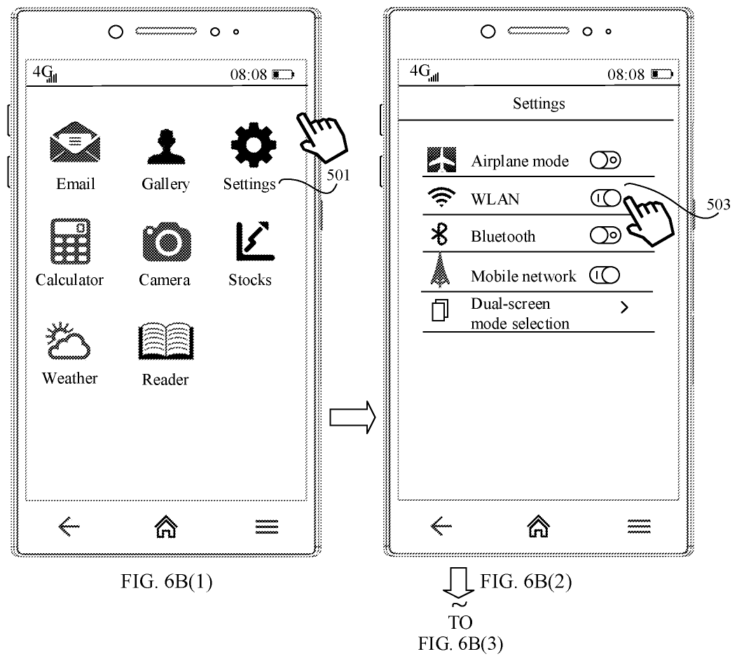

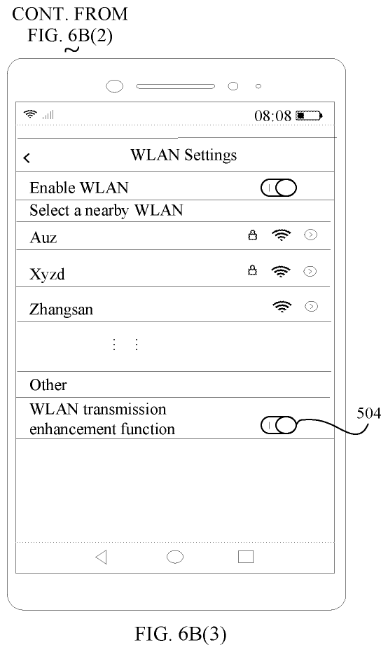

Alternatively, in some other embodiments, a switch may be disposed in the electronic device, and a user may manually enable or disable, by using the switch, a function of improving WLAN transmission performance of the electronic device provided in embodiments of this application. For example, as shown in (1) in FIG. 6A and (2) in FIG. 6A, an on/off control 501 may be set on a setting page of a “Settings” application 501, so that the user enables or disables the WLAN transmission enhancement function (that is, a first function for improving data transmission performance) provided in embodiments of this application. For another example, as shown in FIG. 6B(1), in response to a tap operation performed by the user on a “Settings” application 501, the electronic device displays a setting interface shown in FIG. 6B(2); and in response to a tap operation performed by the user on a WLAN switch 503 on the setting interface, the electronic device displays a WLAN setting interface shown in FIG. 6B(3). The WLAN setting interface includes a switch 504 which may be used to enable or disable a function of improving WLAN transmission performance in embodiments of this application. After an instruction (a first instruction) of the user for enabling the switch 504 is received, the WLAN transmission enhancement function may be enabled.

For another example, in some embodiments, the WLAN transmission performance enhancement function may be enabled on setting interfaces of different applications. For example, the WLAN transmission performance enhancement function is enabled on a setting interface of a “HUAWEI Video” application.

For another example, a video call service is performed through MeeTime. When the switch 504 shown in FIG. 6B(3) is turned on, and a mobile phone is having a MeeTime video, a data frame may be sent to a peer call end both in a discovery window and outside the discovery window, for example, a data frame of a video image and an audio data frame are sent to the peer call end both in the discovery window and outside the discovery window, so as to improve resource utilization.

For another example, when the switch 504 shown in FIG. 6B(3) is turned on, and the mobile phone is having the MeeTime video, if a first condition is met, a data frame is allowed to be sent in a discovery window. For detailed descriptions of the first condition, refer to the following embodiment.

Alternatively, in some other embodiments, when detecting that a preset scenario is met, the electronic device enables the WLAN transmission enhancement function, that is, allows, by using the method provided in embodiments of this application, a data frame to be sent in a discovery window, so as to improve WLAN transmission performance of the electronic device. The preset scenario may include but is not limited to one or a combination of the following conditions: The electronic device starts a preset application; a to-be-sent data frame is a data frame of the preset application; the electronic device enables a preset function of the preset application; and the to-be-sent data frame is a data frame of the preset function.

Optionally, the preset application is an application of a low-latency service, for example, an instant messaging application or a game application. The preset application may be set by the electronic device, or may be set by the user. For example, the electronic device enables WLAN transmission enhancement functions of some applications of service type by default.

In this way, after it is detected that a preset application (for example, video live streaming software) is started, a data frame of the preset application may be sent in a discovery window in a timely manner, and a data frame does not need to be sent after the discovery window ends, so that a low latency of a service can be ensured, and a waste of time domain resources caused by waiting for the discovery window to end can be avoided.

Optionally, the preset function of the preset application includes but is not limited to a function of a low-latency service. The function of the low-latency service includes but is not limited to a voice call function, a video call function, a projection function, and the like.

In embodiments of this application, after detecting the preset scenario, a first electronic device may automatically enable a WLAN transmission performance enhancement function, or prompt a user to enable the WLAN transmission performance enhancement function. For an application that enables a WLAN transmission enhancement function, the method for transmitting data in a WLAN provided in embodiments of this application may be used to improve transmission performance of the application in a data frame transmission (for example, sending and/or receiving) process.

For example, as shown in FIG. 7(3), the user may trigger, through an operation such as tapping a control 601, the mobile phone to pop up a control 603. The control is used to set a corresponding WLAN transmission enhancement function when a target application is started. If the user selects “Automatically use the WLAN transmission enhancement function when the target application is started”, after subsequently detecting that the target application is started, the mobile phone may use the technical solutions in embodiments of this application. To be specific, if the target application has a to-be-sent data frame, the data frame may be allowed to be sent in a discovery window.

Optionally, the electronic device may further provide an entry for setting the target application (or referred to as the preset application). FIG. 7(3) is still used as an example. The mobile phone may display a control 602. If a user operation such as tapping the control 602 is detected, the mobile phone may jump to an interface 604 shown in FIG. 7(4). Through the interface 604, the user may receive a second instruction input by the user, and set the target application. Subsequently, the data frame of the target application may be sent in the discovery window, so that a service delay of the target application can be reduced.

It should be noted that the foregoing setting entry that is provided by the electronic device for the user and that is used to set the application that enables the WLAN transmission enhancement function is merely an example, and the setting entry (including but not limited to setting through an interface) may be another setting entry.

In some other embodiments, after detecting an operation used to enable a Wi-Fi function (for example, turning on a Wi-Fi switch), the first electronic device may automatically enable or prompt the user to enable a function of improving WLAN transmission performance.

A specific manner for enabling a function of improving WLAN transmission performance is not limited in embodiments of this application.

Optionally, to improve data transmission performance between different devices in a cluster, WLAN transmission enhancement functions of a plurality of devices in the cluster may be enabled in any one of the foregoing manners. For example, both a master device and a slave device in the cluster enable the foregoing WLAN transmission enhancement function.

### Embodiment 1

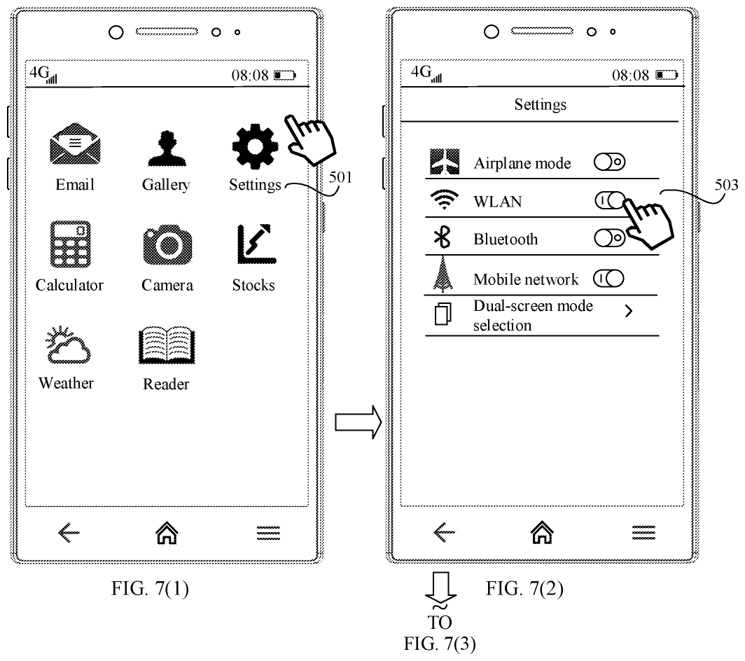

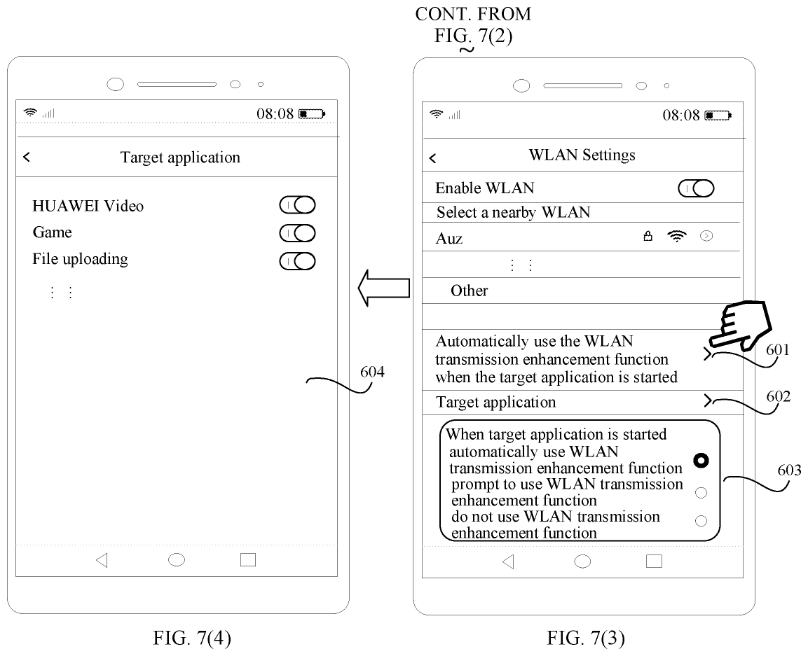

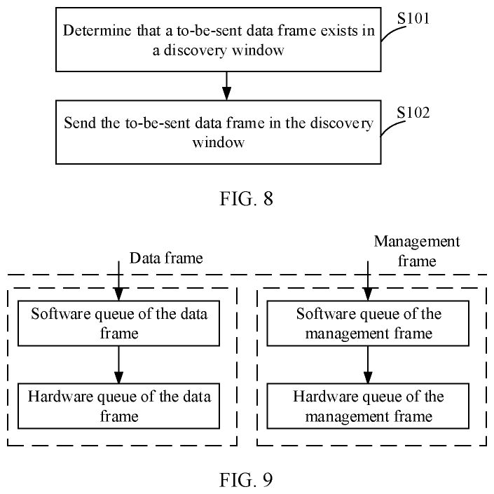

The following describes in detail a method for transmitting data in a WLAN provided in an embodiment of this application. As shown in FIG. 8, the method may include the following steps.

S101: A first electronic device determines that a to-be-sent data frame exists in a discovery window.

The first electronic device may be a master device or a slave device in a first cluster. This is not limited herein. A network in which the first cluster is located is a first network.

In a possible implementation, the first electronic device may store, in a storage area such as a queue, data generated by an upper-layer application, and when the data needs to be sent, extract the corresponding data from the queue and send the data. For example, the queue is an area for storing a frame. Optionally, in embodiments of this application, a data frame and a management frame may be stored in different queues. Optionally, a queue may include a software queue and a hardware queue. For example, FIG. 9 shows an example of a queue used in embodiments of this application. The first electronic device may store a data frame generated by the upper-layer application into a hardware queue of the data frame. In some examples, when the hardware queue is full of data frames, the first electronic device stores the data frame generated by the upper-layer application into a software queue of the data frame. In some examples, when the software queue of the data frame is also filled, a subsequently generated data frame may be discarded. Similarly, the first electronic device may also store a to-be-sent management frame in a queue corresponding to the management frame. A queue corresponding to the management frame may also be classified into a software queue and a hardware queue. For working principles of the software queue and the hardware queue of the management frame, refer to the software queue and the hardware queue of the data frame.

It should be noted that, that a to-be-sent data frame exists in a discovery window may mean that a to-be-sent data frame already exists in a data frame queue in a time period corresponding to the discovery window, or that a to-be-sent data frame newly arrives at a data frame queue in a time period corresponding to the discovery window. In this case, the first electronic device may perform step S102, that is, send the to-be-sent data frame in the discovery window, to improve resource utilization and reduce a service latency.

S102: The first electronic device sends the to-be-sent data frame in the discovery window.

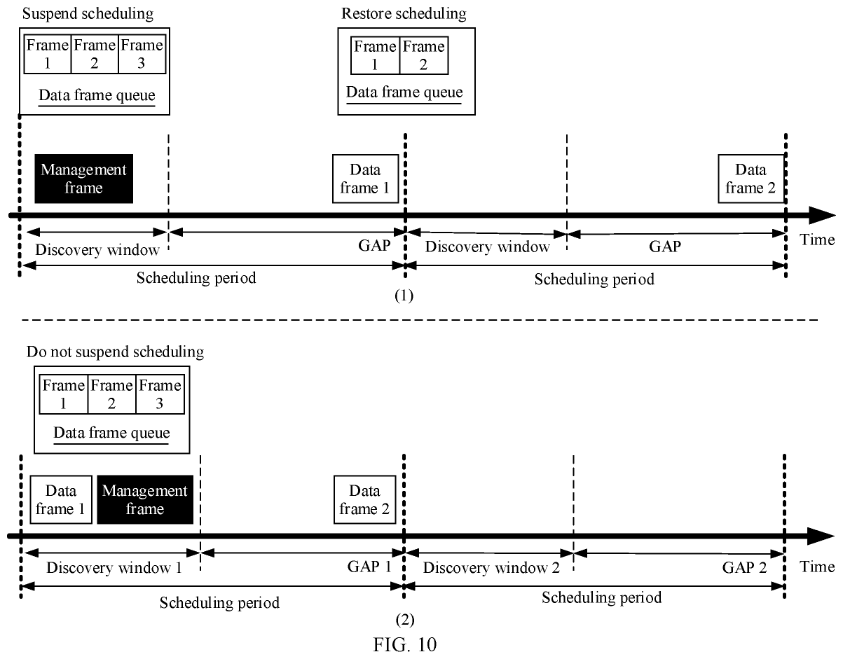

For example, (2) in FIG. 10 shows a relationship between queue scheduling and a discovery window in this embodiment of this application. A frame 1, a frame 2, and a frame 3 in FIG. 10 are data frames. It can be seen that, in the discovery window, scheduling processing of the data frame queue is not suspended. Optionally, scheduling processing of the software queue and the hardware queue of the data frame is not suspended when the discovery window is switched to. In other words, when there is a data frame that needs to be sent in the software queue or the hardware queue, the to-be-sent data frame may be directly scheduled and sent in the discovery window. However, in the solution (the solution of the conventional technology) shown in (1) in FIG. 10, in the discovery window, scheduling processing of the data frame queue is suspended, and the scheduling processing of the data frame queue is resumed only after the discovery window ends, so that the data frame cannot be sent in the discovery window in a timely manner. This causes a service delay and wastes idle resources in the discovery window. It can be learned that, in comparison with the conventional technology, in the data transmission method in this embodiment of this application, the data frame is allowed to be sent in the discovery window, so that a service latency can be reduced as much as possible, resource utilization can be improved, and higher WLAN performance can be obtained.

In addition, in comparison with the conventional technology in which queue scheduling processing is suspended in the discovery window, causing a high probability that queue overflow may occur and a data frame is discarded, in this embodiment of this application, scheduling processing of the data frame is not suspended, which may also be considered that scheduling processing of the data frame is not interrupted, so that the to-be-sent data frame can be extracted from the queue and sent in a timely manner, and more storage areas can be provided for the queue. This further reduces a probability of queue overflow and reduces data frame discarding caused by queue overflow.

For example, the device 200 in FIG. 1 is a master device, and the first electronic device is the device 200. If the device 200 determines that a to-be-sent data frame exists in a current data frame queue and is currently in a discovery window, the device 200 may send the data frame in the discovery window in a timely manner. In this way, resource utilization can be improved and a service latency can be reduced. However, in the conventional technology, if the device 200 determines that a to-be-sent data frame exists in a current data frame queue and is currently in a discovery window, the device 200 needs to wait until the discovery window ends before sending the data frame. Therefore, resource utilization is low, and a service latency is long.

For another example, the device 100 in FIG. 1 is a slave device, and the first electronic device is the device 100. If the device 100 determines that a to-be-sent data frame exists in a current data frame queue and is currently in a discovery window (for example, a discovery window 1 shown in (2) in FIG. 10), the device 100 may send the to-be-sent data frame in the discovery window. If the device 100 determines that a to-be-sent data frame exists in a current data frame queue and is currently outside the discovery window (for example, a GAP 1 shown in (2) in FIG. 10), the device 100 may send the to-be-sent data frame in the GAP 1. In other words, when determining that the to-be-sent data frame exists in the data frame queue, the device may directly send the to-be-sent data frame according to a preset policy, and does not need to determine, based on whether the data frame is currently in the discovery window, whether the data frame is allowed to be sent.

Optionally, the data frame and the management frame may be distinguished based on a 2-bit type field in a Wi-Fi MAC frame format. Optionally, 10 represents a data frame (Data frame), 00 represents a management frame, 01 represents a control frame, and 11 represents an extension frame (extension frame). The management frame, control frame and extension frame may be collectively referred to as management frames. FIG. 11 shows an example of a MAC frame format. The type field in the bold box may be used to distinguish between a data frame and a management frame. It may be understood that, this is merely an example for distinguishing between the data frame and the management frame herein. In actual implementation, a field of any other bit in another frame format may be used. Due to limited space, all possible cases are not exhaustively listed in embodiments of this application.

### Embodiment 2

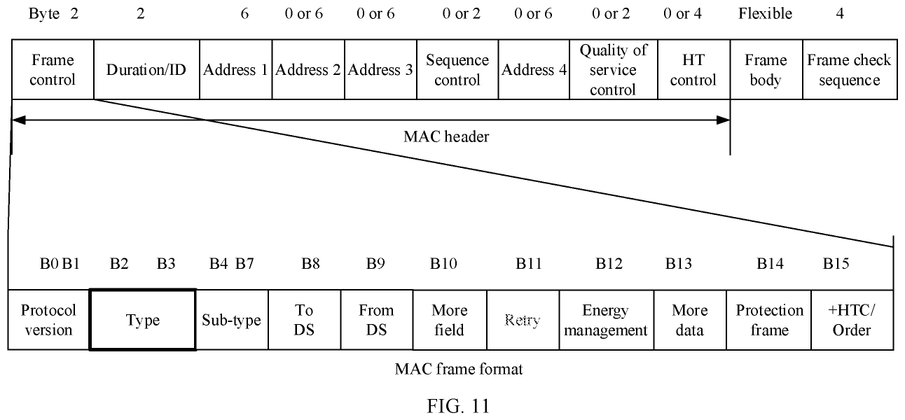

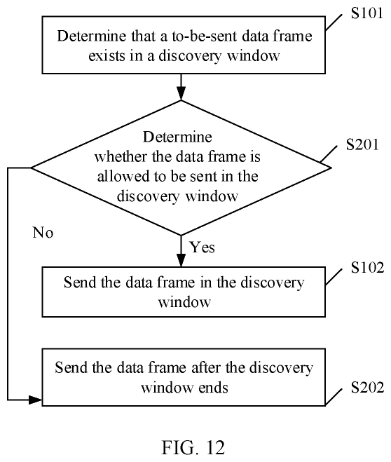

An embodiment of this application further provides a data transmission method. FIG. 12 shows an example flowchart of Embodiment 2. As shown in FIG. 12, before step S102 in Embodiment 1, step S201 may be performed to determine whether a data frame is allowed to be sent in a discovery window. If the data frame is allowed to be sent in the discovery window, a first electronic device performs step S102; or if the data frame is not allowed (disabled) to be sent in the discovery window, the first electronic device performs step S202 to send the data frame after the discovery window ends.

Optionally, that the first electronic device determines whether a data frame is allowed to be sent in a discovery window may be implemented as follows: The first electronic device determines whether a first condition for allowing the first electronic device to send the data frame in the discovery window is met; and if the first condition is met, the first electronic device allows the data frame to be sent in the discovery window; or if the first condition is not met, the first electronic device does not allow the data frame to be sent in the discovery window. Alternatively, that the first electronic device determines whether a data frame is allowed to be sent in a discovery window may be implemented as follows: Another electronic device (for example, a second electronic device in a cluster) determines whether the first electronic device is allowed to send the data frame in the discovery window, and if the first electronic device is allowed to send the data frame in the discovery window, the second electronic device notifies the first electronic device that the first electronic device is allowed to send the data frame in the discovery window (that is, first indication information); or if the first electronic device is not allowed to send the data frame in the discovery window, the second electronic device notifies the first electronic device that the first electronic device is not allowed to send the data frame in the discovery window.

Optionally, that the second electronic device determines whether the first electronic device is allowed to send a data frame in a discovery window may be implemented as follows: The second electronic device determines whether a first condition is met; and if the first condition is met, the second electronic device notifies the first electronic device that the data frame is allowed to be sent in the discovery window; or if the first condition is not met, the second electronic device notifies the first electronic device that the data frame is not allowed to be sent in the discovery window.

Optionally, the first condition includes any one or a combination of the following conditions: a channel busy ratio of the discovery window is less than a first threshold, a packet loss rate of a network in which the cluster is located is less than a second threshold, a retransmission rate of the network in which the cluster is located is less than a third threshold, a quantity of devices in the cluster is less than a fifth threshold, a received signal strength indicator (received signal strength indication, RSSI) is greater than a sixth threshold, and a service priority of a to-be-sent data frame is greater than a fourth threshold.

Optionally, the foregoing thresholds may be preset, for example, preset before delivery, or may be set in a subsequent communication process. A manner of setting the threshold and a specific value of the threshold are not limited in embodiments of this application.

Generally, when a quantity of devices in the cluster is small, a quantity of management frames exchanged between the devices in the discovery window is also small, and these management frames may occupy only a small part of time domain resources of the discovery window. In this case, a large quantity of idle time domain resources may exist in the discovery window. In this embodiment of this application, if the first electronic device determines that there is a to-be-sent data frame, and a quantity of devices in the cluster is less than the fifth threshold, the first electronic device may send the data frame by using the idle time domain resources of the discovery window. For example, in a Wi-Fi-based carrier sense mechanism, when it is sensed that a channel is idle, the data frame is sent in the discovery window. In this way, utilization of time domain resources in the discovery window can be improved, and a waste of air interface resources can be avoided. In addition, the data frame is sent in the discovery window in a timely manner, so that a latency of the data frame can be reduced, and a service latency can be further reduced.

On the contrary, if the first electronic device determines that there is a to-be-sent data frame, and a quantity of devices in the cluster is greater than or equal to the fifth threshold (which indicates that air interface contention is strong), the data frame is not allowed to be sent in the discovery window, that is, the to-be-sent data frame needs to be sent after the current discovery window ends. In this way, a management frame loss caused by the air interface contention can be avoided.

In some scenarios, a small packet loss rate of a network indicates a good network condition and a small degree of contention between devices in the discovery window. In this case, there may be a large quantity of idle time domain resources in the discovery window. In consideration of this case, in this embodiment of this application, if the first electronic device determines that a packet loss rate of the network is less than the second threshold, the data frame is allowed to be sent in the discovery window, so as to efficiently use idle time domain resources. On the contrary, if the first electronic device determines that a packet loss rate of the network is greater than or equal to the second threshold, the data frame is not allowed to be sent in the discovery window, so as to avoid contending for resources of the discovery window by excessive devices.

In some scenarios, when a service priority of a to-be-sent data frame is high, the to-be-sent data frame usually needs to be preferentially sent, to meet a service indicator requirement. Optionally, a high-priority service may include but is not limited to a low-latency service. For example, the low-latency service includes but is not limited to any one or more of the following: a game, an online course, instant messaging, live streaming, red packet grabbing, projection, an Internet of Things service, and an industrial Internet of Things service.

In this embodiment of this application, if the first electronic device determines that there is a to-be-sent data frame, and a service priority of the to-be-sent data frame is greater than (higher than) the fourth threshold, the first electronic device is allowed to send the to-be-sent data frame in the discovery window, to meet a service requirement as much as possible. On the contrary, if the first electronic device determines that there is a to-be-sent data frame, and a service priority of the to-be-sent data frame is less than or equal to the fourth threshold, the first electronic device is not allowed to send the to-be-sent data frame in the discovery window.

In some scenarios, a received signal strength indicator (received signal strength indication, RSSI) of a device that indicates strong signal strength represents a good network condition. In this case, in the discovery window, a degree of contention between devices is usually small, and a quantity of idle time domain resources may exist in the discovery window. In consideration of this case, in this embodiment of this application, if the first electronic device determines that there is a to-be-sent data frame and detects that an RSSI is greater than the sixth threshold, the to-be-sent data frame is allowed to be sent in the discovery window. On the contrary, if the first electronic device determines that there is a to-be-sent data frame and detects that an RSSI is less than or equal to the sixth threshold, the to-be-sent data frame is not allowed to be sent in the discovery window.

Optionally, the first electronic device or another device in the cluster may collect statistics on a value of each parameter in the first condition according to a period or another policy, and the first electronic device may determine, based on a statistical value, whether the data frame is allowed to be sent in the discovery window.

For example, the first electronic device may detect a packet loss rate of the network in a period of time before the discovery window, for example, a packet loss rate of the network in the first half of the discovery window. If the packet loss rate in the first half of the discovery window is less than a threshold, it may be inferred that a packet loss rate in the second half of the discovery window is also small. In this case, the first electronic device allows the data frame to be sent in the second half of the discovery window. On the contrary, if a packet loss rate in the first half of the discovery window is greater than or equal to the threshold, the data frame is not allowed to be sent in the second half of the discovery window.

Alternatively, the first electronic device determines, by determining packet loss rates in discovery windows of first N (N is a positive integer) scheduling periods, whether to send the data frame in the discovery window of the current scheduling period. For example, if a packet loss rate in a discovery window of a previous scheduling period is less than a threshold, it may be inferred that a packet loss rate in the current discovery window is also small. In this case, the first electronic device allows a data frame to be sent in the current discovery window. On the contrary, if a packet loss rate in the previous discovery window is greater than or equal to the threshold, the data frame is not allowed to be sent in the current discovery window.

Alternatively, the first electronic device determines the packet loss rate of the network in the discovery window in another manner. A specific implementation of determining the packet loss rate in the discovery window is not limited in embodiments of this application.

For example, if the mobile phone determines that a to-be-sent data frame (a data frame that needs to be sent in a discovery window) exists in the discovery window, and a current packet loss rate of a cluster network in which the mobile phone is located is small, the mobile phone may send the data frame in the discovery window.

For another example, if the mobile phone determines that a to-be-sent data frame (a data frame that needs to be sent in a discovery window) exists in the discovery window, and a current retransmission rate of a cluster network in which the mobile phone is located is small, the mobile phone may send the data frame in the discovery window.

For another example, if the mobile phone determines that a to-be-sent data frame exists in a discovery window, and a service priority of the data frame is high (for example, a red packet grabbing service), the mobile phone may send the data frame in the discovery window.

For another example, if the mobile phone determines that a to-be-sent data frame exists in a discovery window, and a current RSSI of a cluster network in which the mobile phone is located is large, the mobile phone may send the data frame in the discovery window.

For another example, if the mobile phone determines that a to-be-sent data frame exists in a discovery window, a service priority of the data frame is high (for example, a red packet grabbing service), and a quantity of current devices in a cluster is small, the mobile phone may send the data frame in the discovery window.

For another example, if a “MeeTime” application enables a WLAN transmission enhancement function in embodiments of this application, when a subsequent quantity of devices in a cluster is small, data of MeeTime may be sent in a discovery window.

For another example, if a “MeeTime” application enables a WLAN transmission enhancement function in embodiments of this application, and a voice call is a high-priority service, when a user subsequently performs a voice call through the “MeeTime” application, the electronic device may send voice data in the discovery window.

It may be understood that, in addition to the foregoing several conditions, the first condition may be any other condition that may indicate that the discovery window has an idle time domain resource. Specific content of the first condition is not limited in embodiments of this application.

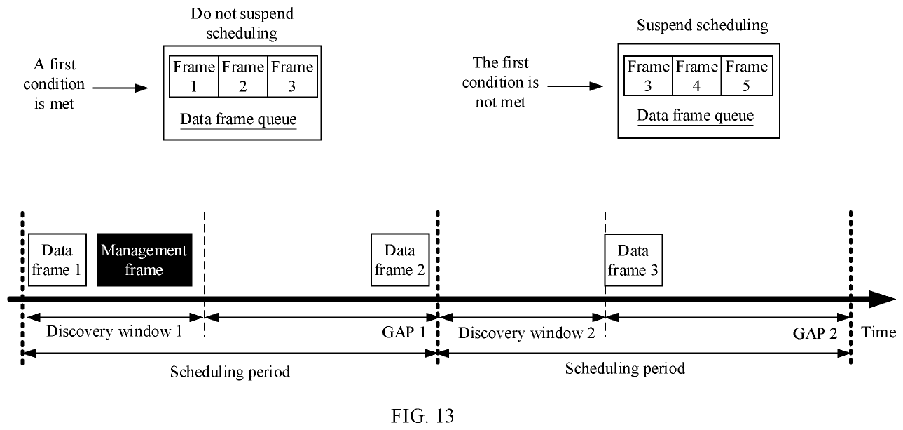

For example, as shown in FIG. 13, during a discovery window 1, to-be-sent data frames 1, 2, and 3 exist in a data frame queue. In this case, if the first condition is met (for example, a quantity of devices in the cluster is small), the first electronic device may schedule the data frame to be sent in the discovery window 1 in a timely manner, for example, schedule the data frame 1 to be sent. During a discovery window 2, to-be-sent data frames 3, 4, and 5 exist in a data frame queue. In this case, if the first condition is not met (for example, a quantity of devices in the cluster is large), the first electronic device cannot schedule the data frame to be sent in the discovery window 2, and can schedule the data frame to be sent only after the discovery window 2 ends.

In comparison with the technical solution in Embodiment 1 in which the data frame is allowed to be sent in the discovery window by default, in the technical solution in Embodiment 2, whether the data frame is allowed to be sent in the discovery window may be dynamically adjusted based on the first condition, so that the data frame can be allowed to be sent in the discovery window under a proper condition.

Optionally, the first condition (a condition used to determine whether a data frame is allowed to be sent in a discovery window) may be determined by the first electronic device. Alternatively, another device in the cluster may determine the first condition, and send a determining result of the first condition to the first electronic device, for example, an indication message indicating whether the first electronic device is allowed to send the data frame in the discovery window. In this way, the first electronic device can determine whether the data frame is allowed to be sent in the discovery window. The following two manners of determining the first condition are separately described.

Optionally, the first electronic device or the another device in the cluster may determine the first condition according to a period or another policy. For example, whether the first condition is met may be determined once in each scheduling period. As shown in FIG. 13, there are two scheduling periods. If the first condition is met in the 1^{st} scheduling period, the first electronic device may send the data frame in the discovery window. If the first condition is not met in the 2^{nd} scheduling period, the first electronic device needs to wait until the discovery window ends before sending the data frame. When a detection period is short, scheduling policies in different discovery windows may be adjusted in a timely manner, so that a service latency can be further reduced, and resource utilization can be adjusted in a timely manner.

For another example, whether the first condition is met may be determined once every L (L is a positive integer) scheduling periods. A specific period and manner of determining the first condition are not limited in embodiments of this application. When the detection period is long, complexity of detecting the first condition may be reduced.

### Embodiment 3

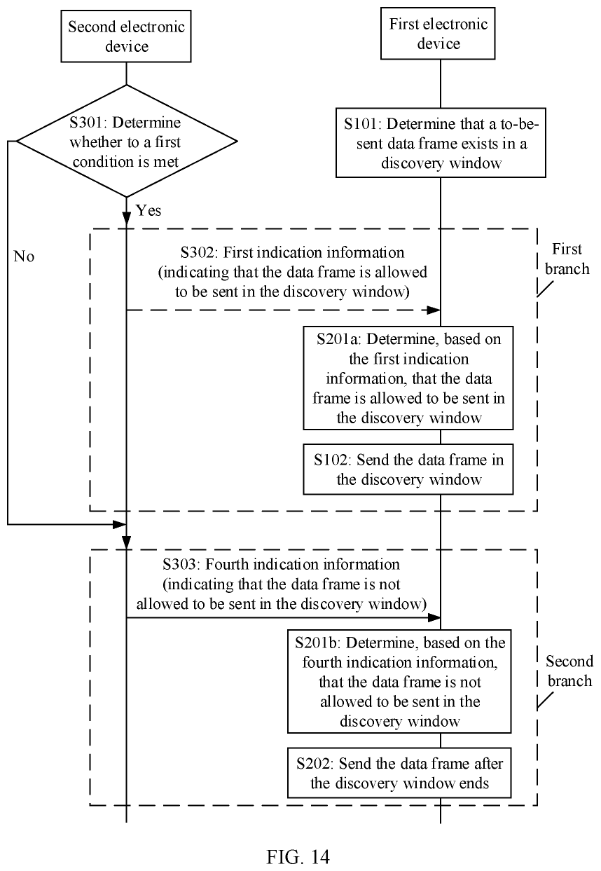

An embodiment of this application further provides a data transmission method. Another device determines a first condition, and sends, to a first electronic device, a determining result of the first condition, for example, an indication message indicating whether the first electronic device is allowed to send a data frame in a discovery window. As shown in FIG. 14, the method includes the following steps.

S301: A second electronic device determines whether a first condition is met. If the first condition is met, step S302 is performed; or if the first condition is not met, S303 is performed.

For specific descriptions of the first condition, refer to the foregoing embodiment.

S302: The second electronic device sends first indication information to a first electronic device.

In a possible implementation, the second electronic device broadcasts the first indication information in a discovery window. Correspondingly, the first electronic device receives the first indication information in the discovery window.

The first indication information indicates that the first electronic device is allowed to send a data frame in the discovery window.

S303: The second electronic device sends fourth indication information to the first electronic device.

In a possible implementation, the second electronic device broadcasts the fourth indication information in the discovery window. Correspondingly, the first electronic device receives the fourth indication information in the discovery window.

The fourth indication information indicates that the data frame is not allowed to be sent in the sending window.

S101: The first electronic device determines that a to-be-sent data frame exists in a discovery window.

In this embodiment of this application, after receiving indication information from the second electronic device, the first electronic device may determine, based on the indication information, whether the data frame is allowed to be sent in the discovery window, and send the data frame based on the indication information. In some cases, if the indication information indicates that the data frame is allowed to be sent in the discovery window, the first electronic device performs the following steps S201a and S102. In some other cases, if the indication information indicates that the data frame is allowed to be sent in the discovery window, the first electronic device performs the following steps S201b and S202.

S201a: The first electronic device determines, based on the first indication information, that the data frame is allowed to be sent in the discovery window.

Step S201a may be considered as a branch of step S201.

S102: The first electronic device sends the data frame in the discovery window.

S201b: The first electronic device determines, based on the fourth indication information, that the data frame is not allowed to be sent in the discovery window.

Step S201b may be considered as another branch of step S201.

S202: The first electronic device sends the data frame after the discovery window ends.

It may be understood that, in a case in which it is determined that the data frame is not allowed to be sent in the discovery window, the first electronic device needs to wait until the discovery window ends before sending the data frame.

In some other embodiments, the first electronic device may further determine whether the second electronic device is allowed to send the data frame in the discovery window. If the second electronic device is allowed to send the data frame in the discovery window, second indication information is sent to the second electronic device and indicates that the second electronic device is allowed to send the data frame in the discovery window; or if the second electronic device is not allowed to send the data frame in the discovery window, third indication information is sent to the second electronic device and indicates that the second electronic device is not allowed to send the data frame in the discovery window.

In some other embodiments, the first electronic device may further determine whether a second condition for allowing the second electronic device to send the data frame in the discovery window is met; and if the second condition is met, the first electronic device sends second indication information to the second electronic device, where the second indication information indicates that the data frame is allowed to be sent in the discovery window; or if the second condition is not met, the first electronic device sends third indication information to the second electronic device, where the third indication information indicates that the data frame is not allowed to be sent in the discovery window.

Optionally, the second condition includes any one or more of the following: a channel busy ratio of a first network is less than a first threshold, a packet loss rate of the second electronic device is less than a second threshold, a retransmission rate of the second electronic device is less than a third threshold, a quantity of devices in a first cluster is less than a fifth threshold, a service priority of the second electronic device is greater than a fourth threshold, and an RSSI of the second electronic device is greater than a sixth threshold.

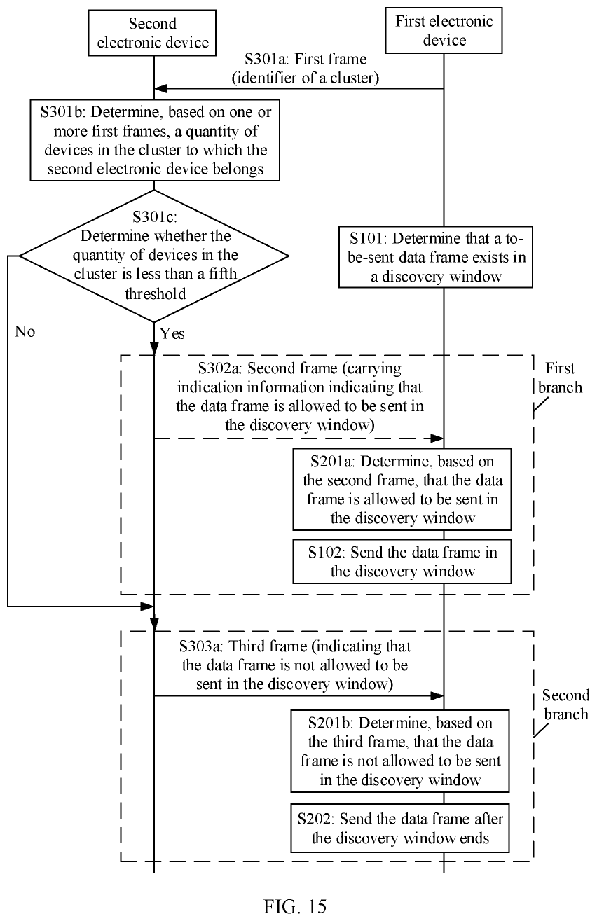

For example, FIG. 15 shows an interaction procedure of a data transmission method according to an embodiment of this application when the first condition is that a quantity of devices in the cluster is less than the fifth threshold. Step S301 in FIG. 14 may be implemented as S301a to S301c in FIG. 15. As shown in FIG. 15, the method includes the following steps.

S301a: A first electronic device sends a first frame to a second electronic device.

Correspondingly, the second electronic device receives the first frame from the first electronic device. Optionally, the first frame carries an identifier of a cluster to which the first electronic device belongs.

S301b: The second electronic device determines, based on one or more first frames, a quantity of devices in the cluster to which the second electronic device belongs.

It may be understood that the second electronic device may receive first frames from all devices other than the second electronic device in the cluster, and may determine the quantity of devices in the cluster based on the cluster identifiers in the first frames. For example, if an identifier of the cluster to which the second electronic device belongs is 10, first frames from 10 devices are received, and these first frames indicate that the 10 devices are all in the cluster with the identifier 10, the second electronic device may determine that the quantity of devices in the cluster is 11 (including the second electronic device).

It should be noted that the second electronic device may be a master device or a slave device, and the first electronic device may also be a master device or a slave device.

For example, if the second electronic device is a master device, and the first electronic device is a slave device, the first frame may be but is not limited to a period notification frame, a second frame may be but is not limited to a beacon frame, and a third frame may be but is not limited to a beacon frame. The second electronic device may receive period notification frames from all devices other than the second electronic device in the cluster, and may determine the quantity of devices in the cluster based on the cluster identifiers in the period notification frames.

For example, if the second electronic device is a slave device, and the first electronic device may be another slave device and a master device in the cluster, the first frame may be but is not limited to a period notification frame or a beacon frame, a second frame may be but is not limited to a period notification frame, and a third frame may be but is not limited to a period notification frame. The second electronic device may receive period notification frames from all slave devices other than the second electronic device in the cluster, receive a beacon frame from the master device, and may determine the quantity of devices in the cluster based on the cluster identifiers in the period notification frames and the beacon frame.

S301c: The second electronic device determines whether the quantity of devices in the cluster is less than the fifth threshold. If the quantity of devices in the cluster is less than the fifth threshold, step S302a is performed. If the quantity of devices in the cluster is not less than the fifth threshold, step S303a is performed.

S302a: The second electronic device sends the second frame.

The second frame indicates that a data frame is allowed to be sent in a discovery window.

It may be understood that, when the quantity of devices in the cluster is small, resources used by the devices are usually small, and a resource idle probability is high. To improve resource utilization, a device in the cluster may be allowed to send the data frame in the discovery window.

In a possible implementation, the second electronic device broadcasts the second frame in the discovery window. Correspondingly, another device (for example, the first electronic device shown in FIG. 15) in the cluster receives the second frame in the discovery window.

S101: The first electronic device determines that a to-be-sent data frame exists in a discovery window.

S201a: The first electronic device determines, based on the second frame, that the data frame is allowed to be sent in the discovery window.

It may be understood that, after receiving the second frame from the second electronic device, the first electronic device may determine, based on an indication of the second frame, that the data frame is allowed to be sent in the discovery window, and may perform the following step S102.

S102: The first electronic device sends the data frame in the discovery window.

S303a: The second electronic device sends the third frame.

The third frame indicates that the data frame is not allowed to be sent in the discovery window.

In a possible implementation, the second electronic device broadcasts the third frame in the discovery window. Correspondingly, another device (for example, the first electronic device) in the cluster may receive the third frame in the discovery window.

S201b: The first electronic device determines, based on the third frame, that the data frame is not allowed to be sent in the discovery window.

S202: The first electronic device sends the data frame after the discovery window ends.

FIG. 15 shows only one possible implementation of determining the quantity of devices in the cluster. The quantity of devices in the cluster may be alternatively determined in another manner. Due to limited space, all implementations are not exhaustively listed in embodiments of this application.

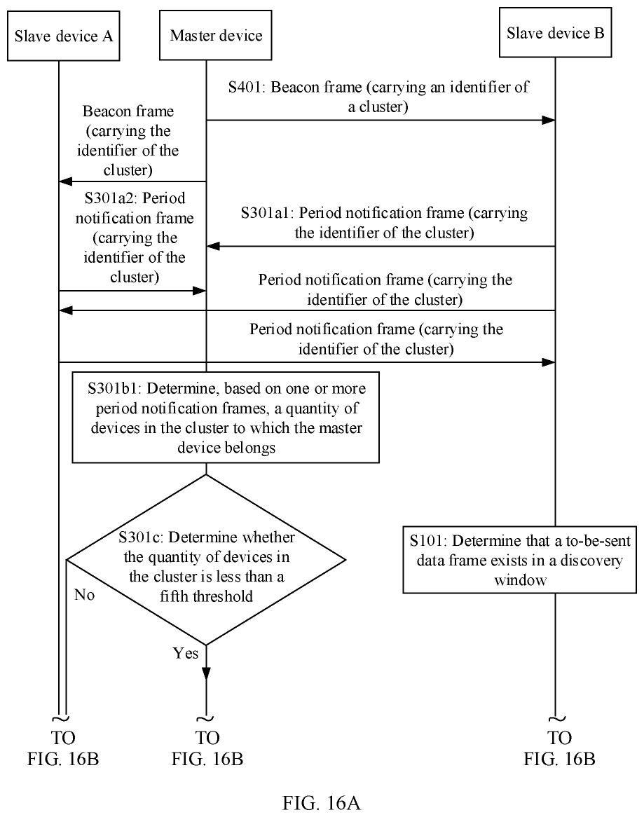

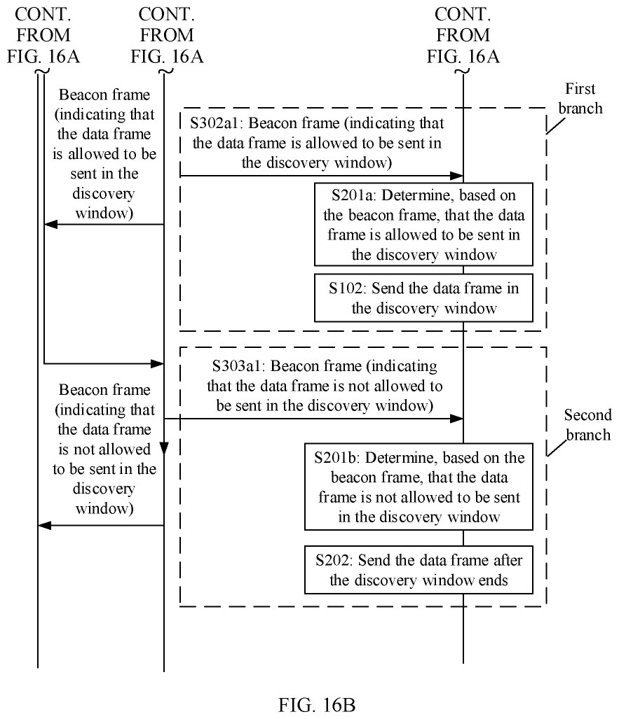

The following describes the method corresponding to FIG. 15 by using an example in which the second electronic device is a master device and the first electronic device is a slave device. As shown in FIG. 16A and FIG. 16B, the method includes the following steps.

S401: The master device sends a beacon frame.

It should be noted that FIG. 16A and FIG. 16B show only two slave devices in a cluster, that is, slave devices A and B, as an example. The cluster may further include another slave device, which is not shown in FIG. 16A and FIG. 16B.

Optionally, the master device broadcasts the beacon frame in a discovery window. Correspondingly, the slave device in the cluster receives the beacon frame in the discovery window. For example, in FIG. 16A and FIG. 16B, both the slave device A and the slave device B may receive the beacon frame from the master device.

Optionally, the beacon frame carries a master device election attribute, and the election attribute includes an identifier (ID) of the cluster. The beacon frame may indicate the cluster to which the master device belongs. Optionally, the ID of the cluster may be but is not limited to a basic service set identifier (basic service set identifier, BSSID) of the master device in the cluster.

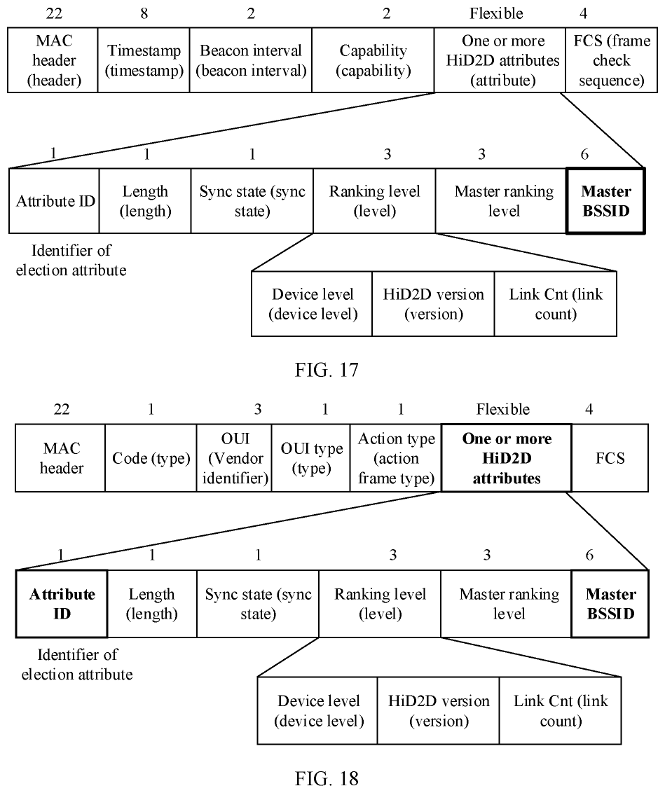

For example, FIG. 17 shows an example of a possible frame format of a beacon frame. The beacon frame includes a field of one or more customized attributes (One or More HiD2D Attributes). The one or more attributes include an election attribute. The election attribute carries the BSSID (master BSSID) of the master device.

S301a1: The slave device B sends a period notification frame (an example of a first frame).

Optionally, the slave device B broadcasts the period notification frame in the discovery window. Correspondingly, the master device receives the period notification frame from the slave device B in the discovery window. The another slave device in the cluster receives the period notification frame from the slave device B in the discovery window. For example, the slave device A receives the period notification frame from the slave device B.

Optionally, the period notification frame sent by the slave device carries the master device election attribute, and the election attribute includes the ID of the cluster. The period notification frame may indicate the cluster to which the device belongs. Optionally, the ID of the cluster may be but is not limited to the BSSID of the master device in the cluster.

For example, FIG. 18 shows an example of a possible frame format of a period notification frame, and shows a possible format of an election attribute.

It should be noted that, in embodiments of this application, that a message or field indicates a meaning does not mean that the message or field is a message or field dedicated to indicating the meaning. The message or field may further have another function.

S301a2: The slave device A sends a period notification frame.

S301b1: The master device determines, based on one or more period notification frames, a quantity of devices in the cluster to which the master device belongs.

In a possible implementation, the master device matches a cluster ID in the period notification frame, to obtain the quantity of devices in the cluster.

For example, if a cluster ID (for example, a BSSID) of the master device is 11, a cluster ID of the slave device A is 11, and a cluster ID of the slave device B is 11, the master device determines that both the slave devices A and B are devices in the cluster, and the quantity of devices in the cluster is 2 (excluding the master device) or 3 (including the master device).

S301c: The master device determines whether the quantity of devices in the cluster is less than a fifth threshold. If the quantity of devices in the cluster is less than the fifth threshold, step S302a1 is performed; or if the quantity of devices in the cluster is not less than the fifth threshold, step S303a1 is performed.

S302a1: The master device sends a beacon frame (an example of a second frame).

In a possible implementation, the master device broadcasts the beacon frame in the discovery window. Correspondingly, the slave device receives the beacon frame from the master device in the discovery window. For example, in FIG. 16A and FIG. 16B, both the slave device A and the slave device B may receive the beacon frame from the master device.

The beacon frame carries indication information. The indication information indicates that the data frame is allowed to be sent in the discovery window.

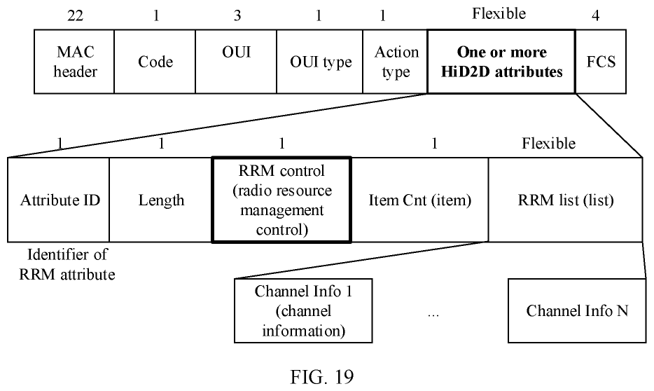

For example, as shown in FIG. 19, the beacon frame carries a field of one or more attributes (One or More HiD2D Attributes), where the one or more attributes include a radio resource management (radio resource management, RRM) attribute, the RRM attribute carries an RRM control (control) field, and the RRM control field indicates whether to a data frame is allowed to be sent in a discovery window. Optionally, the indication information may be a field value of the RRM control field.

For example, in some examples, as shown in FIG. 19, an RRM control (control) field occupies one byte (eight bits), and the indication information may be represented by 1 bit in the RRM control (control) field. For example, as shown in Table 1, the 2^{nd} bit of the RRM control (control) field may represent the indication information. In some examples, if the 2^{nd} bit of the RRM control (control) field is 1, it indicates that a data frame is allowed to be sent in a discovery window; or if the 2^{nd} bit of the RRM control field is 0, it indicates that a data frame is not allowed to be sent in a discovery window. Alternatively, if the 2^{nd} bit of the RRM control field is 0, it indicates that a data frame is allowed to be sent in a discovery window; or if the 2^{nd} bit of the RRM control field is 1, it indicates that a data frame is not allowed to be sent in a discovery window.

TABLE 1
RRM control field in a beacon frame

| RRM control field | Meaning |
|---|---|
| 1^{st} bit | Indicating a QoE reporting mode |
| 2^{nd} bit | Indication information (indicating whether a data |
| | frame is allowed to be sent in a discovery |
| | window) |
| 3^{rd} bit to 8^{th} bit | Reserved |

Alternatively, it may be understood that any one of the 3^{rd} bit to the 8^{th} bit in the RRM control field may represent the indication information. A specific implementation of the indication information is not limited in embodiments of this application.

S101: The slave device B determines that a to-be-sent data frame exists in a discovery window.

In this embodiment of this application, after receiving the beacon frame from the master device, the slave device B may parse the beacon frame to obtain the indication information. If the indication information indicates that the data frame is allowed to be sent in the discovery window, the slave device B may perform the following steps S201a and S102.

S201a: The slave device B determines, based on the beacon frame, that the data frame is allowed to be sent in the discovery window.

In a possible implementation, the slave device B determines, based on the indication information in the beacon frame, that the data frame is allowed to be sent in the discovery window.

S102: The slave device B sends the data frame in the discovery window.

S303a1: The master device sends a beacon frame (an example of a third frame).

The beacon frame carries indication information. The indication information indicates that the data frame is not allowed to be sent in the discovery window.

In a possible implementation, the master device broadcasts the beacon frame in the discovery window. Correspondingly, each slave device receives the beacon frame in the discovery window.

It may be understood that, after receiving the beacon frame from the master device, the slave device B may parse the beacon frame to obtain the indication information. If the indication information indicates that the data frame is not allowed to be sent in the discovery window, the slave device B may perform the following steps S201b and S202.

S201b: The slave device B determines, based on the beacon frame, that the data frame is not allowed to be sent in the discovery window.

S202: The slave device B sends the data frame after the discovery window ends.

### Embodiment 4

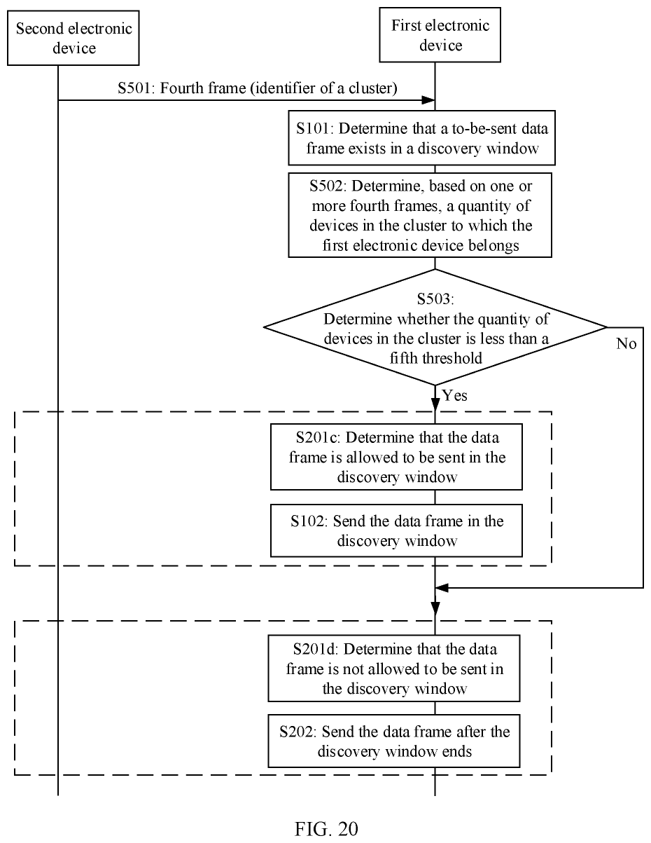

An embodiment of this application further provides a data transmission method. A first electronic device determines, according to a specific policy, whether a first condition is met. The following describes the data transmission method by using an example in which the first condition is that a quantity of devices in a cluster is less than a fifth threshold. As shown in FIG. 20, the method includes the following steps.

S501: A second electronic device sends a fourth frame to a first electronic device.

Correspondingly, the first electronic device receives the fourth frame from the second electronic device.

Optionally, the fourth frame carries an identifier of a cluster.

S101: The first electronic device determines that a to-be-sent data frame exists in a discovery window.

S502: The first electronic device determines, based on one or more fourth frames, a quantity of devices in the cluster to which the first electronic device belongs.

The first electronic device may be a master device or a slave device, and the second electronic device may be a master device or a slave device.

In some examples, if the first electronic device is a slave device, the fourth frame may be a period notification frame of another slave device in the cluster and a beacon frame of a master device in the cluster. The first electronic device determines, based on the period notification frames from all the other slave devices in the cluster and the beacon frame of the master device in the cluster, the quantity of devices in the cluster to which the first electronic device belongs.

In some other examples, if the first electronic device is a master device, the fourth frame may be a period notification frame of a slave device in the cluster, and the first electronic device determines the quantity of devices in the cluster based on cluster identifiers carried in these period notification frames.

S503: The first electronic device determines whether the quantity of devices in the cluster is less than a fifth threshold. If the quantity of devices in the cluster is less than the fifth threshold, step S201c and step S102 are performed; or if the quantity of devices in the cluster is not less than the fifth threshold, step S201d and step S202 are performed.

S201c: The first electronic device determines that the data frame is allowed to be sent in the discovery window.

S102: The first electronic device sends the data frame in the discovery window.

S201d: The first electronic device determines that the data frame is not allowed to be sent in the discovery window.

S202: The first electronic device sends the data frame after the discovery window ends.

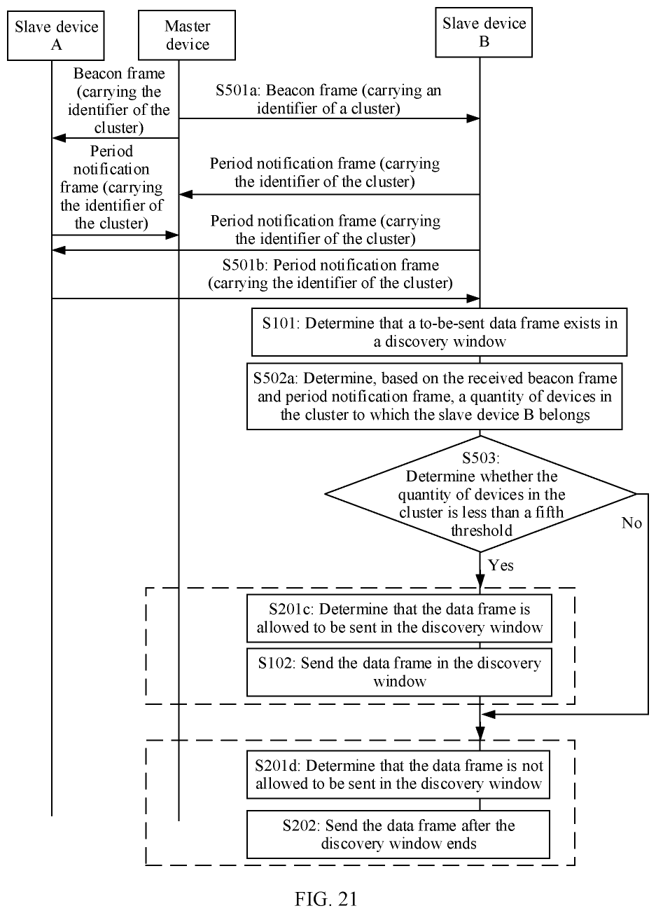

The following describes the embodiment corresponding to FIG. 20 by using an example in which the first electronic device is a slave device. As shown in FIG. 21, the method includes the following steps.

S501a: A master device sends a beacon frame.

Optionally, the master device carries an identifier of a cluster.

In a possible implementation, the master device broadcasts the beacon frame in a discovery window. Correspondingly, a slave device in the cluster receives the beacon frame in the discovery window.

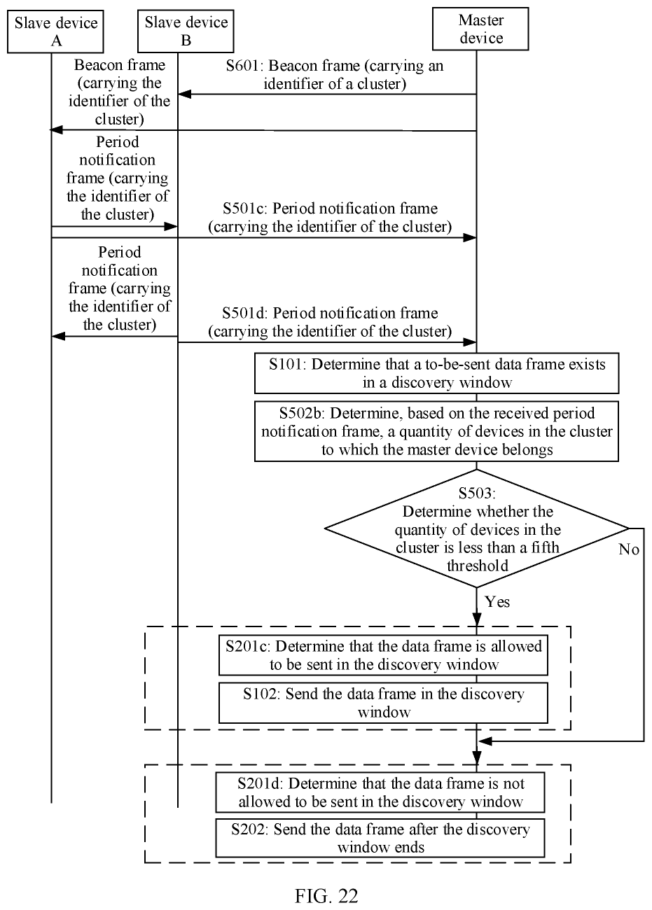

It should be noted that, in FIG. 21 and the following FIG. 22, an example in which the cluster includes slave devices A and B is used for description. The cluster may further include another slave device, which is not shown in the figures.

For example, in FIG. 21, both the slave device A and the slave device B may receive the beacon frame from the master device.

S501b: The slave device A sends a period notification frame.

Optionally, the period notification frame carries the identifier of the cluster.

In a possible implementation, the slave device broadcasts a period notification frame in the discovery window. Correspondingly, the master device in the cluster receives the period notification frame in the discovery window. Another slave device in the cluster receives the period notification frame in the discovery window.

For example, in FIG. 21, the slave device A broadcasts the period notification frame (carrying a cluster identifier), and both the slave device B and the master device in the cluster can receive the broadcast frame. Similarly, the slave device B also broadcasts a period notification frame (carrying a cluster identifier), and the slave device A and the master device may receive the period notification frame from the slave device B.

S101: The slave device B determines that a to-be-sent data frame exists in the discovery window.

S502a: The slave device B determines, based on the received beacon frame and period notification frame, a quantity of devices in the cluster to which the slave device B belongs.

For example, if the identifier of the cluster to which the slave device B belongs is 10, and the slave device B receives a beacon frame from a master device whose cluster identifier is 10, and receives period notification frames from nine slave devices whose cluster identifiers are 10, the slave device B determines that a quantity of devices in the cluster to which the slave device B belongs is 11.

S503: The slave device B determines whether the quantity of devices in the cluster is less than a fifth threshold. If the quantity of devices in the cluster is less than the fifth threshold, step S201c and step S102 are performed; or if the quantity of devices in the cluster is not less than the fifth threshold, step S201d and step S202 are performed.

S201c: The slave device B determines that the data frame is allowed to be sent in the discovery window.

S102: The slave device B sends the data frame in the discovery window.

S201d: The slave device B determines that the data frame is not allowed to be sent in the discovery window.

S202: The slave device B sends the data frame after the discovery window ends.

The following describes the embodiment corresponding to FIG. 20 by using an example in which the first electronic device is a master device. As shown in FIG. 22, the method includes the following steps.

S601: A master device sends a beacon frame.

Optionally, the master device carries an identifier of a cluster.

In a possible implementation, the master device broadcasts the beacon frame in a discovery window. Correspondingly, a slave device in the cluster receives the beacon frame in the discovery window.

For example, in FIG. 22, both a slave device A and a slave device B may receive the beacon frame from the master device.

S501c: The slave device A sends a period notification frame.

Optionally, the period notification frame carries the identifier of the cluster.

In a possible implementation, the slave device broadcasts a period notification frame in the discovery window. Correspondingly, the master device in the cluster receives the period notification frame in the discovery window. Another slave device in the cluster receives the period notification frame in the discovery window.

For example, in FIG. 22, the slave device A broadcasts the period notification frame (carrying a cluster identifier), and both the slave device B and the master device in the cluster can receive the broadcast frame.

S501d: The slave device B sends a period notification frame.

Optionally, the period notification frame carries the cluster identifier.

For example, the slave device B broadcasts the period notification frame. The slave device A and the master device may receive the period notification frame from the slave device B.

S101: The master device determines that a to-be-sent data frame exists in the discovery window.

S502b: The master device determines, based on the received period notification frame, a quantity of devices in the cluster to which the master device belongs.

For example, if the identifier of the cluster to which the master device belongs is 10, and the master device receives period notification frames from 10 slave devices whose the cluster identifiers are 10, the master device determines that a quantity of devices in the cluster to which the master device belongs is 11.

S503: The master device determines whether the quantity of devices in the cluster is less than a fifth threshold. If the quantity of devices in the cluster is less than the fifth threshold, step S201c and step S102 are performed; or if the quantity of devices in the cluster is not less than the fifth threshold, step S201d and step S202 are performed.

S201c: The master device determines that the data frame is allowed to be sent in the discovery window.

S102: The master device sends the data frame in the discovery window.

S201d: The master device determines that the data frame is not allowed to be sent in the discovery window.

S202: The master device sends the data frame after the discovery window ends.

The foregoing mainly describes, by using an example of determining the quantity of devices in the cluster, a manner of determining the first condition. For a specific implementation of another manner of determining the first condition, refer to the prior art. For example, the second electronic device is a master device, and the first electronic device is a slave device. The slave device may carry a service priority and/or a service type and/or an RSSI of the slave device in a period notification frame (PNF) of the slave device. The master device determines, based on the service priority and/or the service type and/or the RSSI, whether the first condition is met, and if the first condition is met, indicates the slave device to send a data frame in a discovery window. For another example, the first electronic device may detect a packet loss rate and a retransmission rate of a network, and determine, based on the packet loss rate and the retransmission rate, whether the first condition is met. For another example, the first electronic device may identify, based on deep packet inspection (deep packet inspection, DPI), an access control list (access control list, ACL), a port, and the like, a service type to which a data frame belongs, so as to determine a priority of a service.

### Embodiment 5

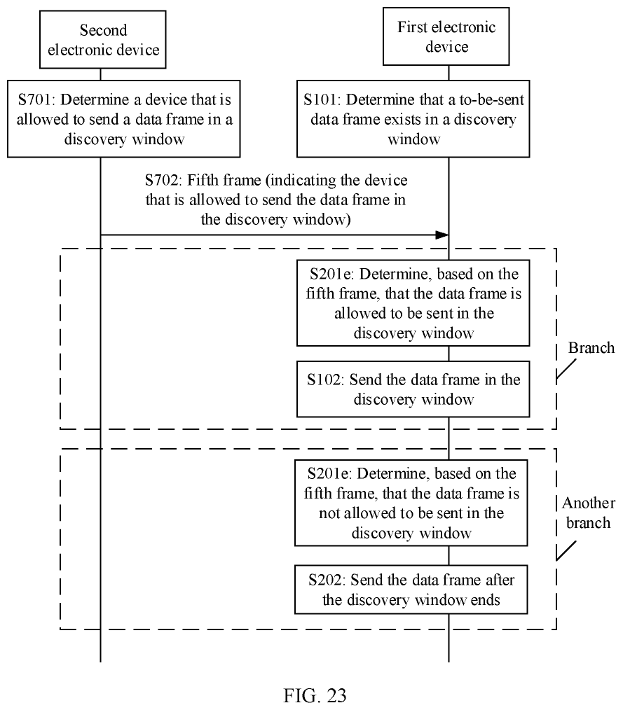

An embodiment of this application further provides a data transmission method, to allow some devices in a cluster to send a data frame in a discovery window. As shown in FIG. 23, the method includes the following steps.

S701: A second electronic device determines a device that is allowed to send a data frame in a discovery window.

Optionally, the second electronic device is a master device. In some other embodiments, the second electronic device may alternatively be a slave device. A role of the second electronic device is not limited in embodiments of this application.

It may be understood that the second electronic device may determine which devices are allowed to send a data frame in the discovery window. Optionally, the second electronic device may allow, by default, each device in a cluster to send a data frame in the discovery window.

Alternatively, optionally, the second electronic device determines whether a second condition for allowing a first electronic device to send the data frame in the discovery window is met, and if the second condition is met, the first electronic device is allowed to send the data frame in the discovery window. Optionally, the second condition includes but is not limited to any one or more of the following: a channel busy ratio of a first network is less than a first threshold, a packet loss rate of the first electronic device is less than a second threshold, a retransmission rate of the first electronic device is less than a third threshold, a quantity of devices in a first cluster is less than a fifth threshold, an RSSI of the first electronic device is greater than a sixth threshold, and a service priority of the first electronic device is greater than a fourth threshold.

Optionally, a channel of the first network in which the cluster is located may refer to a common channel in the discovery window, and the common channel may be used to transmit a management frame between devices. The channel busy ratio of the first network may refer to a busy degree of the common channel.

S702: The second electronic device sends a fifth frame to the first electronic device.

Correspondingly, the first electronic device receives the fifth frame from the second electronic device.

Optionally, the fifth frame indicates the device that is allowed to send the data frame in the discovery window.

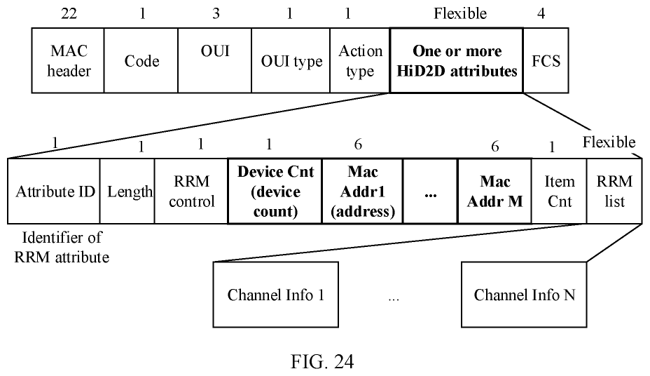

For example, the second electronic device is a master device, and the fifth frame is a beacon frame. As shown in FIG. 24, the beacon frame carries one or more attributes (One or More HiD2D Attributes). The one or more attributes include an RRM attribute. An indication field of the RRM attribute includes a device count (Device Cnt) field, and the device count field may indicate a quantity of devices that are allowed to send the data frame in the discovery window. A media access control address (Mac Addr) field may indicate a MAC address of the device that is allowed to send the data frame in the discovery window.

Alternatively, in some other embodiments, in an RRM control field shown in FIG. 24, 1 bit is used to indicate that the data frame is allowed to be sent in the discovery window, a device count (Device Cnt) field is defaulted or deleted, and a MAC address of the device that is allowed to send the data frame in the discovery window is listed after the RRM control field.

S101: The first electronic device determines that a to-be-sent data frame exists in the discovery window.

S201e: The first electronic device determines, based on the fifth frame, that the data frame is allowed to be sent in the discovery window.

It may be understood that, if the first electronic device determines that the data frame is allowed to be sent in the discovery window, S102 is performed.

S102: The first electronic device sends the data frame in the discovery window.

For example, after receiving the beacon frame shown in FIG. 24, the first electronic device parses the beacon frame, and reads a MAC address field. If the MAC address field indicates a MAC address of the first electronic device, it indicates that the first electronic device is allowed to send a data frame in the discovery window. In this case, the first electronic device may send the data frame in the discovery window in a timely manner, to improve resource utilization.

S201e: The first electronic device determines, based on the fifth frame, that the data frame is not allowed to be sent in the discovery window.

For example, after receiving the beacon frame shown in FIG. 24, the first electronic device parses the beacon frame, and reads a MAC address field. If a MAC address indicated by the MAC address field does not include a MAC address of the first electronic device, it indicates that the first electronic device is not allowed to send a data frame in the discovery window, and the first electronic device needs to perform S202.

S202: The first electronic device sends the data frame after the discovery window ends.

In some other implementations, the data frame sent by the first electronic device in the discovery window meets any one or more of the following conditions: a data amount is less than a seventh threshold, a sending rate is less than an eighth threshold, and a quantity of times of sending is less than a ninth threshold. In this way, a problem that the discovery window is congested because the first electronic device sends too much data in the discovery window can be avoided, and stability of network performance can be maintained.

Optionally, the seventh threshold, the eighth threshold, and the ninth threshold may be preset. For example, the seventh threshold, the eighth threshold, and the ninth threshold are preset before delivery of a device, or may be dynamically interacted between devices. Optionally, the seventh threshold, the eighth threshold, and the ninth threshold may be determined based on a current network condition. For example, when the quantity of devices in the cluster is large, the seventh threshold is correspondingly small; and when the quantity of devices in the cluster is large, the seventh threshold is correspondingly large. In this manner, the data amount, the sending rate, and the quantity of times of sending that are sent by the device in the discovery window may be dynamically adjusted by adjusting a value of each threshold, so that the data amount, the sending rate, and the quantity of times of sending match a current network status, thereby obtaining higher data transmission performance.

Optionally, in embodiments of this application, a WLAN transmission enhancement function may be automatically enabled. After the WLAN transmission enhancement function is enabled, the electronic device may send the data frame in the discovery window. In this implementation, WLAN transmission performance can be improved without user awareness.

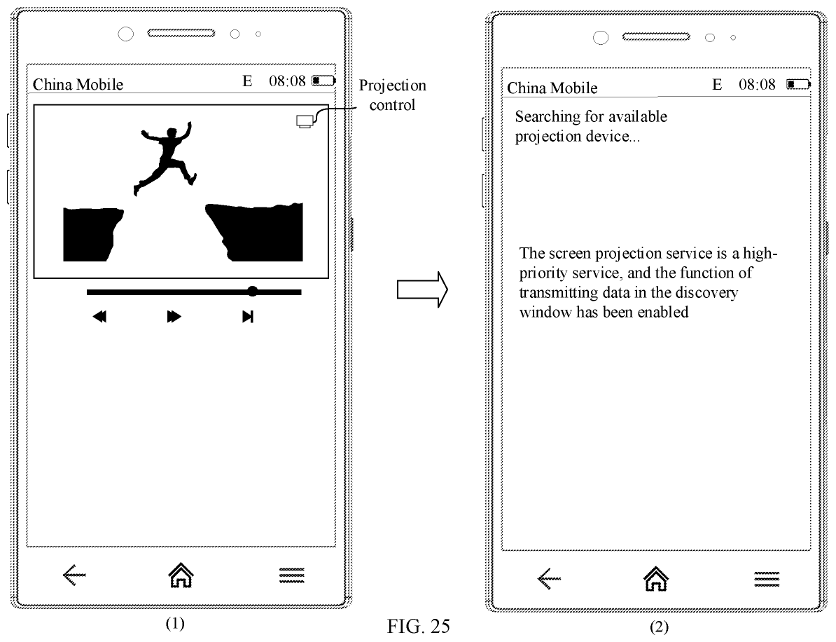

Optionally, in some other embodiments, after enabling the WLAN transmission enhancement function, the electronic device presents a prompt interface, to indicate that the WLAN transmission enhancement function is enabled. For example, as shown in (1) in FIG. 25, a mobile phone is searching for a projection device, and the mobile phone determines that projection is a high-priority service, and automatically enables a WLAN transmission enhancement function. The mobile phone may further display an interface shown in (2) in FIG. 25, to prompt a user that the WLAN transmission enhancement function is enabled.

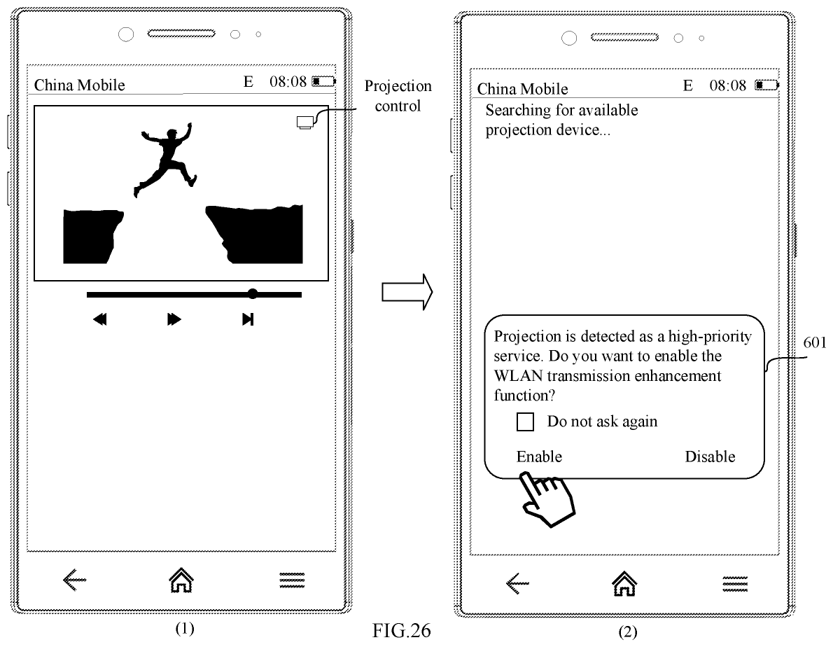

In some other embodiments, before enabling the WLAN transmission enhancement function, the electronic device presents a prompt interface, to ask the user whether to enable the WLAN transmission enhancement function. For example, as shown in (1) in FIG. 26, the mobile phone is searching for a projection device, and the mobile phone determines that the projection is a high-priority service, and displays an interface shown in (2) in FIG. 26. The interface includes a control 601, used to prompt the user whether to enable a WLAN transmission enhancement function. When the user indicates to enable the WLAN transmission enhancement function, the mobile phone may send a data frame in a discovery window.

Fields and frames in embodiments of this application are all examples. During actual implementation of the technical solution, used information may be further encapsulated in another field of another frame.

The interfaces in embodiments of this application are all examples, and a specific presentation manner and effect of the interfaces are not limited in embodiments of this application.

The foregoing technical solutions may be applied to a communication process between devices in a cluster, or may be applied to a communication process between devices in different clusters. This is not limited in embodiments of this application.

It should be noted that some operations in the procedures of the foregoing method embodiments are optionally combined, and/or a sequence of some operations is optionally changed. In addition, an execution sequence between steps of each process is merely an example, and does not constitute a limitation on an execution sequence between the steps. The steps may be alternatively performed in another execution sequence. It is not intended to indicate that the execution order is the only order in which these operations may be performed. A person of ordinary skill in the art may learn various manners to reorder the operations described in this specification. In addition, it should be noted that process details related to an embodiment in this specification are also applicable to other embodiments in a similar manner, or different embodiments may be used in combination.

For example, in FIG. 14, an execution sequence between step S101 and step S302 is not limited.

In addition, some steps in the method embodiments may be equivalently replaced with other possible steps. Alternatively, some steps in the method embodiments may be optional, and may be deleted in some use scenarios. Alternatively, another possible step may be added to the method embodiments.

In addition, the foregoing method embodiments may be implemented separately or in combination.

For the accompanying drawings that are not described in detail in embodiments of this application, refer to related text descriptions in other accompanying drawings. For example, for text descriptions of the accompanying drawings such as FIG. 7(1) and FIG. 7(2), refer to text descriptions of other similar accompanying drawings. Similar descriptions are not described again in embodiments of this application.

Some other embodiments of this application provide an apparatus. The apparatus may be the foregoing electronic device (the first electronic device or the second electronic device). The apparatus may include a memory and one or more processors. The memory is coupled to the processor. The memory is configured to store computer program code. The computer program code includes computer instructions. When the processor executes the computer instructions, the electronic device may perform functions or steps performed by the mobile phone in the foregoing method embodiments. For a structure of the electronic device, refer to the electronic device shown in FIG. 4 or FIG. 3.

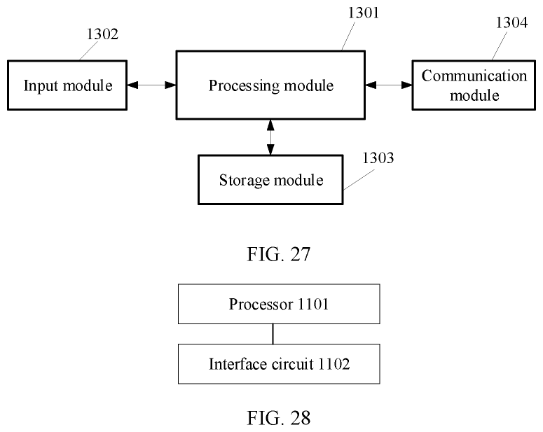

A core structure of the electronic device may be represented as a structure shown in FIG. 27. The core structure may include a processing module 1301, an input module 1302, a storage module 1303, and a communication module 1304.

The processing module 1301 may include at least one of a central processing unit (CPU), an application processor (Application Processor, AP), or a communication processor (Communication Processor, CP). The processing module 1301 may perform an operation or data processing related to control and/or communication of at least one of other elements of the user electronic device.

The input module 1302 is configured to obtain an instruction or data input by a user, and transmit the obtained instruction or data to another module of the electronic device. For example, the input module may obtain an input operation of the user, generate an input signal based on the obtained input operation, and transmit the input signal to the processing module 1301. If the electronic device is a mobile phone, in embodiments of this application, the input module may be configured to receive a setting instruction input by the user, and/or perform another step.

The storage module 1303 may include a volatile memory and/or a nonvolatile memory. The storage module is configured to store at least one related instruction or data of another module of the user terminal device.

The communication module 1304 is configured to support the electronic device in communicating with another electronic device. For example, the communication module may be connected to a network through wireless communication or wired communication, to communicate with another personal terminal or a network server. The wireless communication may use at least one of cellular communication protocols, such as long term evolution (LTE), long term evolution advanced (LTE-A), code division multiple access (CDMA), wideband code division multiple access (WCDMA), universal mobile telecommunications system (UMTS), wireless broadband (WiBro), or a global system for mobile communications (GSM). The wireless communication may include, for example, short-range communication. The short-range communication may include at least one of wireless fidelity (Wi-Fi), Bluetooth, near field communication (NFC), magnetic stripe transmission (MST), or GNSS.

An embodiment of this application further provides a chip system. The chip system may be applied to the first electronic device or the second electronic device. As shown in FIG. 28, the chip system includes at least one processor 1101 and at least one interface circuit 1102. The processor 1101 and the interface circuit 1102 may be interconnected through a line. For example, the interface circuit 1102 may be configured to receive a signal from another apparatus (for example, a memory of the first electronic device 100). For another example, the interface circuit 1102 may be configured to send a signal to another apparatus (for example, the processor 1101). For example, the interface circuit 1102 may read instructions stored in the memory, and send the instructions to the processor 1101. When the instructions are executed by the processor 1101, the first electronic device is enabled to perform steps performed by the first electronic device 100 (for example, the mobile phone) in the foregoing embodiments. Certainly, the chip system may further include another discrete device. This is not specifically limited in embodiments of this application.

An embodiment of this application further provides an apparatus. The apparatus is included in a first electronic device or a second electronic device, and the apparatus has a function of implementing behavior of the first electronic device or the second electronic device in any method in the foregoing embodiments. The function may be implemented by hardware, or may be implemented by executing corresponding software by hardware. The hardware or the software includes at least one module or unit corresponding to the foregoing function, for example, a detection module or unit, and a determining module or unit.

An embodiment of this application further provides a computer-readable storage medium including computer instructions. When the computer instructions are run on a first electronic device or a second electronic device, the first electronic device or the second electronic device is enabled to perform any method in the foregoing embodiments.

An embodiment of this application further provides a computer program product. When the computer program product runs on a computer, the computer is enabled to perform any method in the foregoing embodiments.

It can be understood that, to implement the foregoing functions, the electronic device (for example, the first electronic device or the second electronic device) includes corresponding hardware structures and/or software modules for performing the functions. A person skilled in the art should be easily aware that, in combination with the examples of units, algorithms, and steps described in embodiments disclosed in this specification may be implemented by hardware or a combination of hardware and computer software in embodiments of this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of embodiments of the present invention.

In embodiments of this application, functional module division may be performed on the electronic device and the like according to the foregoing method examples. For example, each functional module may be correspondingly obtained through division based on each function, or two or more functions may be integrated into one processing module. The integrated module may be implemented in a form of hardware, or may be implemented in a form of a software functional module. It should be noted that in embodiments of the present invention, module division is an example, and is merely a logical function division. During actual implementation, another division manner may be used.

A person skilled in the art may clearly learn from the foregoing descriptions of the implementations that, for convenience and brevity of description, division into the foregoing functional modules is only used as an example for description. During actual application, the foregoing functions may be allocated to different functional modules for implementation based on a requirement, that is, an inner structure of an apparatus is divided into different functional modules, to complete all or some of the functions described above. For a detailed working process of the foregoing system, apparatus, and unit, refer to a corresponding process in the foregoing method embodiments. Details are not described herein again.

Functional units in embodiments of this application may be integrated into one processing module, or each of the units may physically exist alone, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of embodiments of this application essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor to perform all or some of the steps of the methods described in embodiments of this application. The foregoing storage medium includes any medium that can store program code, such as a flash memory, a removable hard disk, a read-only memory, a random access memory, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1-26. (canceled)

27. A data transmission method for a first electronic device when connected to a first cluster of a first network, the method comprising:
determining that a to-be-sent data frame exists in a discovery window;
receiving first indication information from a second electronic device, wherein the first indication information indicates that the data frame is allowed to be sent in the discovery window; and the second electronic device is a master device; and
sending the data frame in the discovery window based on the first indication information.

28. The method according to claim 27, wherein the determining that a to-be-sent data frame exists in a discovery window comprises detecting that a to-be-sent data frame already exists in a time period corresponding to the discovery window or detecting that a to-be-sent data frame newly arrives in a time period corresponding to the discovery window.

29. The method according to claim 27, further comprising receiving a first instruction input indicating to enable a first function improving data transmission performance.

30. The method according to claim 27, further comprising:
detecting that a preset scenario exists and enabling a first function, wherein the first function is a function of improving data transmission performance, and
the preset scenario comprises one or a combination of the following scenarios:
the first electronic device starts a preset application, and the to-be-sent data frame is a data frame of the preset application; and
the first electronic device enables a preset function of the preset application, and the to-be-sent data frame is a data frame of the preset function.

31. The method according to claim 30, further comprising receiving a second instruction to set the preset application.

32. The method according to claim 27, wherein the data frame sent by the first electronic device in the discovery window meets any one or more of the following conditions: a data amount is less than a seventh threshold, a sending rate is less than an eighth threshold, and a quantity of times of sending is less than a ninth threshold.

33. A first electronic device connectable to a first cluster of a network in which the first cluster is located, the first electronic device comprising:
a processor, configured to determine that a to-be-sent data frame exists in a discovery window; and
a transceiver coupled to the processor and configured to receive first indication information from a second electronic device, the first indication information indicating that the data frame is allowed to be sent in the discovery window, and the second electronic device is a master device; and
the transceiver being configured to send the data frame in the discovery window based on the first indication information.

34. The device according to claim 33, wherein determining that a to-be-sent data frame exists in a discovery window comprises detecting that a to-be-sent data frame already exists in a time period corresponding to the discovery window or detecting that a to-be-sent data frame newly arrives in a time period corresponding to the discovery window.

35. The device according to claim 33, wherein the processor is further configured to receive a first instruction indicating to enable a first function for improving data transmission performance.

36. The device according to claim 33, wherein the processor is further configured to:
detect that a preset scenario exists and enable a first function based upon determining that the preset scenario exists, wherein the first function is a function for improving data transmission performance, and
the preset scenario comprises one or a combination of the following scenarios:
the first electronic device starts a preset application and the to-be-sent data frame is a data frame of the preset application; and
the first electronic device enables a preset function of the preset application and the to-be-sent data frame is a data frame of the preset function.

37. The device according to claim 36, wherein the processor is further configured to receive a second instruction to set the preset application.

38. The device according to claim 33, wherein the data frame sent by the first electronic device in the discovery window meets any one or more of the following conditions: a data amount is less than a seventh threshold, a sending rate is less than an eighth threshold, and a quantity of times of sending is less than a ninth threshold.

39. A master electronic device connectable to a network in which a first cluster of a first network is located, the second electronic device comprising:
a processor configured to determine first indication information; and
a transceiver configured to send the first indication information to a first electronic device, wherein the first indication information indicates that the first electronic device is allowed to send a data frame in a discovery window.

40. The device according to claim 39, determination by the processor of the first indication information comprises determining when a first condition has been met for allowing the first electronic device to send the data frame in the discovery window.

41. The device according to claim 40, wherein the first condition comprises any one or more of the following: a channel busy ratio of the first network is less than a first threshold, a packet loss rate of the first electronic device is less than a second threshold, a retransmission rate of the first electronic device is less than a third threshold, a quantity of devices in the first cluster is less than a fifth threshold, a service priority of the first electronic device is greater than a fourth threshold, or a received signal strength indicator RSSI of the first electronic device is greater than a sixth threshold.

42. The device according to claim 39, wherein the transceiver is further configured to receive a period notification frame from the first electronic device in the discovery window, the period notification frame indicating the cluster to which the first electronic device belongs.

43. The device according to claim 42, wherein the processor is further configured to determine a quantity of devices in the cluster to which the master device belongs based on the period notification frame.

44. The device according to claim 43, wherein the transceiver further configured to send the first indication information to the first electronic device when the quantity of devices in the cluster is less than a fifth threshold.

45. The device according to claim 39, wherein the transceiver is further configured to send a beacon frame to the first electronic device in the discovery window.

46. The device according to claim 45, wherein the beacon frame carries a master device election attribute that includes an identifier of the cluster.
